(19) United States
(12) Patent Application Publication
(10) Pub. No.: US 2002/0051562 A1
(43) Pub. Date: May 2, 2002

(54) Scanning method and apparatus for optical character reading and information processing

(76) Inventors: Clinton E. Sheppard, Mountain Home, AR (US); Edward L. Anderson, Carrolton, TX (US)

Correspondence Address: Stephen D. Carver, 2024 Arkansas Valley Drive, #800, Little Rock, AR, 72212-4139, US

(21) Appl. No.: 09/833,700

(22) Filed: Apr. 11, 2001

Related U.S. Application Data
(60) Provisional application No. 60/196,159, filed on Apr. 11, 2000.

(51) Int. Cl. G06K 9/00

(52) U.S. Cl. 382/137; 382/140

(57) ABSTRACT

A method and apparatus for reading and decoding documents transported through the system in a single, non-reversing pass. An optical sensor array derives a pair of separate and distinct video signals from a scanning sequence where select portions of the document are scanned solely with infrared, and adjacent portions are scanned with visible light. The two, resultant video signals are delivered to separate image processing modules which concurrently process data independently. One module decodes bit images of machine readable characters derived from the infrared scanning sequence, the other module derives an image. Noise is reduced as smudges or extraneous marks are ignored. The first P bits of an initial scan are spatially filtered to yield M intermediate numbers of N bits, where P=M×(N−x2). Each N-bit resultant number corresponding to a predetermined pattern. Combinations of patterns are analyzed to recognize OCR, MICR, and E13B characters.

### CROSS REFERENCE TO RELATED APPLICATION

This application claims the filing date and priority of a prior provisional patent application upon which it is based, the application bearing Ser. No. 60/196,159, and Filing Date Apr. 11, 2000, and entitled “Scanning Method and Apparatus for Optical Character Reading and Information Processing.”

### BACKGROUND OF THE INVENTION

I. Field of the Invention

The present invention relates generally to optical scanning systems for reading various coded indicia on planar documents, and for concurrently developing digital images. More particularly, the invention relates to single-pass, optical imaging scanners that can concurrently read and decode MICR code on checks and the like. Pertinent prior art related to the invention is classified in United States Patent Class 382, Subclasses 7, 135, 137, 139, 140, 181+and others.

II. Description of the Prior Art

An ever increasing volume of commercial transactions are consummated with checks. As will be recognized by those skilled in the art, modern checks are imprinted by the issuing institution with numerous pertinent factual details. For example, details including the name and address of the check customer, the check number, and other data are printed in plain language on the check. Other pertinent information is encoded upon the check in the form of MICR code, that is machine readable with magnetic scanning technology. Other information on the check, such as the money amount and customer-purpose of the transaction is hand written on the check. Finally, the endorser will mark the back side of the check according the negotiable instrument laws in effect in the given jurisdiction.

Typically, an endorsed check then “clears.” It is passed, for example, by a receiving retailer through a deposit in the latter entity's bank, then transferred to a clearing house for mass reading, and from there to the issuing. The bank upon which it is drawn will ultimate decrement the customer's account, and then transfer that check and others back to the originating bank customer or “maker” that wrote the check in the form of a monthly check statement. In the typical check processing scenario, numerous occasions are presented where the check must be read. The advantage of automated check processing systems is readily apparent.

Various optical character recognition systems and document scanning systems have been proposed. Numerous standardized machine readable character-sets exist that employ various machine readable characters. These codes, known to those with skill in the art, are known under various designations, including the acronyms OCR-A, OCR-B, and E13B. 15 Check reading systems, typically employing “MICR characters” printed from magnetic ink, have also evolved. Standard MICR codes, used to affix check account numbers and other indicia to checks, has been in use for several decades. As recognized by those skilled in the art, the aforementioned machine-readable character sets employ “standardized” patterns that indicate various letters and numbers.

A variety of complex systems have been proposed over the years to decode various machine-readable character sets. Numerous optical and/or magnetic schemes have been suggested. Machine-readable characters, including MICR data, can be decoded, stored and processed digitally, and delivered downstream to provide useful information for various uses.

U.S. Pat. No. 5,727,667 teaches that “currency-authentication” can be accomplished by reading and analyzing the “magnetic signature” of the ink on the currency in a process similar to that for “check-validation.” The disclosed device reads magnetizable ink. Transport is provided by a drive-pulsed stepper motor, and associated stepper motor reversing circuitry. The disclosed device includes a magnetizing unit, and magnetic means for Thereafter reading the magnetic MICR code.

U.S. Pat. No. 5,898,157 discloses a method in which a check is moved through a magnetic read station. A stepper motor transports the document through the read station. Transport speed regulation is achieved with “wave-drive pulsing”. An optical sensor is used only to detect the presence of a document (i.e., a check) within the transport mechanism. No reference is made to the optical sensing of MICR characters.

U.S. Pat. Nos. 4,180,799 and 4,180,800 disclose apparatus wherein optical signal patterns are used for identifying printed characters.

The amount of light reflected by the surface of a check during scanning is dependent upon several factors. The most important factor relates to the ink characteristics. The ink absorbs light, leaving only a portion to be reflected. A second important factor affecting how much light is reflected from the check is the surface quality of the check, and the extent of background printing. Surface quality variations can seriously degrade reflected light intensity.

A third significant factor affecting reflected light is the angle between the incident light and the surface of the check. This angle is not constant. It can change locally as the check is moved through the transport mechanism. This is a relatively minor problem and can be controlled by properly designed paper guides. The most difficult factor affecting the angle between the light and the paper surface is a local affect caused by the offset printing process used to print the characters on the check. The pressure used in this printing process causes the paper thickness to be slightly compressed where the characters are printed compared to the thickness of the paper elsewhere. As the distance from the printed character is increased, the paper thickness also increases. This results in a slightly tilted paper surface immediately surrounding each character and between the strokes of an individual character. This slight tilt in the surface of the paper causes the reflected light intensity to decrease as a printed character is approached. This results in blurring at the edges of the character.

This problem is significant. For example, the MICR characters 2, 3, 5 and 8 each have comprise three horizontal lines segments, with at the top, one at the bottom, and one in the middle. The spacing of these horizontal lines is such that the non-printed paper between the lines does not typically recover after the printing process. When vertically scanning these MICR characters, light reflected from these intra-character “white” spaces is less than that for “white” spaces outside the printed character. This phenomena combined with the local variations in surface quality and the printed background make it difficult to establish a fixed detection threshold for determining the difference between the ink and the non printed check surface. As a consequence, it is necessary to use a self compensating detection threshold that automatically adjusts to the local conditions of the unprinted check background.

If the check were scanned for color, then this problem would not be present. Color scanning routines can discriminate between black ink and the colored check background. But, color scanning techniques are much slower, and much more expensive to manufacture. Thus color scanning techniques are unworkable for high speed, low cost check processing. To facilitate speed and low cost without color scanning, a unique detection threshold must be established.

### SUMMARY OF THE INVENTION

This invention provides an automated check reading system that electronically derives information from generally planar documents to be read, including processed checks. Both graphical visual image files, and bit-mapped files corresponding to MICR codes imprinted on checks are developed. Optical imaging and/or visual scanning is accomplished in a single pass through the hardware. Preferably the optical raw bit, optical image is developed concurrently with a an optical, rather than magnetic, read of the standard MICR code.

The system provides a relatively low-cost check processing station ideally adapted for installation at each and every checkout counter in large retail stores, including discount stores, supermarkets and other retail, mass-merchandisers. To speed up check processing speeds, our unit makes no attempt to measure or correlate horizontal distances or dimensions of the check dynamically moving through the system. Preferably the pixel logic system is based upon “vertical information” appearing upon the checks (i.e., indicia scan lines extend from the check top to bottom). MICR code is optically scanned. A read starts with presence sensing, followed by detection of a transit symbol comprising the first character pixel. A sequence of states between extremes of black and white across the MICR coding is optically derived. Unique, recognizable character sequences are determined without synchronizing “reads” or “scans” to specific check positions. Transport mechanisms do not need to be reversed. The software allows scanning and decoding to occur simultaneously.

In this manner, the use of certain transit timing or synchronization circuitry and hardware that is characteristic of many prior art scanning devices is avoided. For example, no stepper motors are required for transport. Further, concurrent positional indexing circuits are obviated. As a result of our unique scanning approach and the associated software, check-reader speed and reliability are increased, while concurrently unit cost and hardware complexity are minimized.

In the preferred embodiment, a dual-mode scanning illumination technique is employed. The MICR characters are scanned only with infrared light, which is beamed by our device only across check regions marked with MICR indicia. Infrared light does not significantly reflect from smudges or pen marks that often mar the surface of checks. The MICR code absorbs about 80% of incident infrared energy, so reliable, “low noise” readings are obtained. After infrared scanning of given vertical segments, visible light is projected upon adjacent non-MICR-code regions to illuminate the remainder of the check surface. Scanning operations are thus divided into “infrared intervals” where only MICR code regions are illuminated, and “visible light intervals” where only adjacent check regions are illuminated for subsequent optical character recognition processing.

A transport mechanism moves a document to be scanned through the apparatus. Documents, i.e., checks, pass an optical imaging station at an essentially constant velocity. The preferred transport mechanism comprises a direct current motor that drives a gear drive assembly, that in turn activates an O-ring assembly. The latter assembly turns spring-loaded back up rollers in contact with the document that is constrained between paper guides for alignment.

When a check is placed in the paper guides, an adjacent optical sensor assembly detects it's presence, and activates a logic level signal for sensing by an associated micro controller. When the micro controller senses the logic level signal it activates a motor drive transistor, causing the motor armature to turn. The motor armature is coupled by the gear drive assembly to the O-ring assembly. For proper operation, the user must manually insert the check far enough into the paper guides so that the leading edge of the check in engaged between the O-ring assembly and the spring loaded back up rollers. When this happens, the transport mechanism will capture and move the check past the imaging station at a nominal speed of three inches per second.

The imaging station comprises a vertical slit in one wall of the paper guides. Light is focused through this slit onto the surface of the check. Visible light will be focused onto the check above the MICR data. Infra red light is directed upon the MICR data. Suitable baffles ensure that light from these two sources do not overlap on the surface of the check. Light reflected by the surface of the check will be captured by the lens and an image of the check will be reconstructed, in focus, on the surface of an electronic, linear, sensor array. The lens structure will reduce the image of the check to match the active length of the linear array sensor.

Complete software control is effectuated by a plurality of concurrently operating microprocessors. The first microprocessor senses check presence, controls the linear array sensor, and activates the transport drive motor upon check detection. The second microprocessor receives bit image data derived from infrared scanning, and decodes it to detect MICR characters. A third microprocessor receives bit image data derived from visible light scanning, and compresses it for later transmission to the host. The latter two microprocessors communicate with the host via RS-232 serial ports, that are preferably capable of 57.6 K baud transmission.

Thus a basic object is to optically scan documents encoded with MICR indicia, and to concurrently develop an optical image, with a single pass of the document through the reading hardware.

A related object is to provide a scanner of the character described that uses only one scanning sensor.

Another important object is to scan selected, separate portions of a document with light of different wavelengths and/or characteristics.

An important object is to provide a scanning or decoding system of the character described that avoids complex transport mechanisms such as stepper motors.

A related object is to provide a scanning system of the character described whose transport mechanisms are simplified. Specifically, it is an important feature of our invention that the check transport mechanism is not required to reverse during operation or to correlate displacement positional information with scanning operations.

Therefore it is an object to avoid the use of slow, cumbersome stepper motors typically employed in the prior art. Equally important, is the fact that out invention thus requires no apparatus to reverse the direction of the motor.

Another object is to avoid the use of inefficient prior art magnetic reading heads.

Another related is to increase decoding efficiency. It is a feature of the invention that the optical techniques developed for scanning MICR code, for example, simplify the required decoding algorithms and thus enhance system accuracy.

Another related object is to provide a scanner of the character described which need not magnetize MICR ink.

These and other objects and advantages of the present invention, along with features of novelty appurtenant thereto, will appear or become apparent in the course of the following descriptive sections.

### BRIEF DESCRIPTION OF THE DRAWINGS

In the following drawings, which form a part of the specification and which are to be construed in conjunction therewith, and in which like reference numerals have been employed throughout wherever possible to indicate like parts in the various views:

FIG. 1 is a fragmentary, exploded pictorial view of the preferred hardware employed in the best mode of our new Optical Character Reading and Information Processing System;

FIG. 2 is a plan view of a typical document to be scanned (i.e., a check), showing typical MICR code indicia, and preferred scanning zones employed by our system;

FIG. 3 is a simplified block diagram of our preferred system;

FIG. 4 is an electrical schematic diagram of the preferred video signal conditioning circuitry;

FIG. 5 is a timing diagram showing analog and digital video detection waveforms pertinent to video bit image conversion;

FIG. 6 is a chart showing typical MICR characters and the compressed scan line arguments derived from them;

FIG. 7 is a chart showing digital scan line signals and resultant binary patterns derived from various MICR characters after spatial filtering,

FIG. 8 is a chart showing the sequence of scan line patterns derived from left-to-right scanning of E13B characters;

FIGS. 9A and 9B are software block diagrams showing the preferred software executive handler routines;

FIGS. 10-13, which should be sequentially placed horizontally left-to-right for combined viewing, are software block diagrams showing the preferred software decoder subroutine;

FIG. 14 is a block diagram showing the preferred “get new line” subroutine;

FIG. 15 is a software block diagram showing the preferred spatial filter; and

FIG. 16 is an electronic schematic diagram of the preferred machine controller circuit;

FIG. 17 is an electronic schematic diagram of the preferred MICR decoder circuit; and,

FIG. 18 is an electronic schematic diagram of the preferred bit image compression and storage circuit.

### DETAILED DESCRIPTION

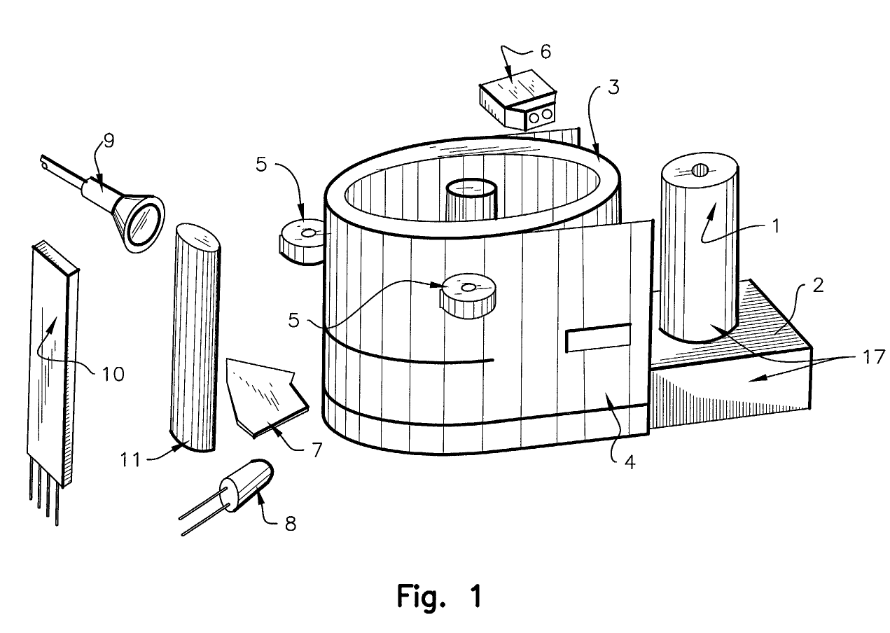

Turning initially to FIGS. 1-3 of the appended drawings, FIG. 1 pictorially discloses the essential hardware mechanisms for scanning documents (i.e., checks) with our system. A permanent magnet DC drive motor 1 is coupled to a drive hub 3 via a gear drive assembly 2, that reduces the 9000 RPM motor output shaft speed by approximately 160:1. The hollow, light weight drive hub 3 is generally cylindrical, and preferably comprises one or more frictional O-rings made of resilient material to move documents or checks contacting it. Silicon rubber O-rings, concentrically mounted to the hub exterior are preferred.

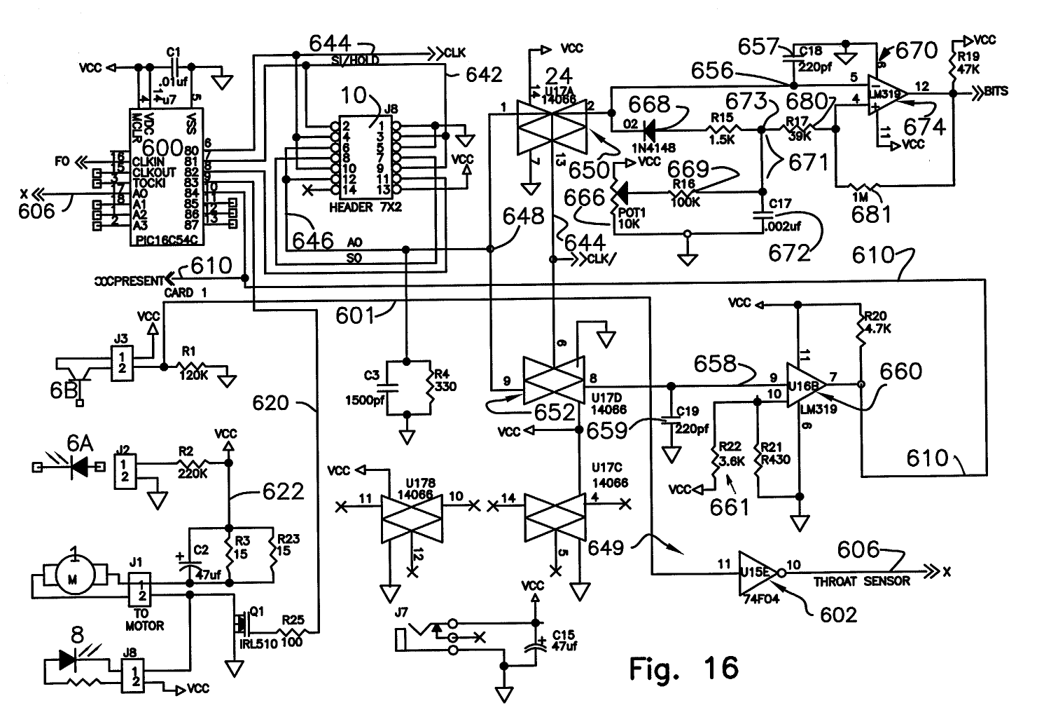

A check 4 to be processed is first inserted into the mechanism between the hub 3 and back-up rollers 5, in the proximity of the throat sensor 6 (FIGS. 1, 3, 16) that in turn activates motor 1. Preferably sensor 6 is a reflective sensor system, comprising an LED 6A (FIG. 16) and a reflective sensor phototransistor 6B (FIG. 16) within the same modular package as explained later. When a document or check 4 is first presented and thus detected, phototransistor 6B (FIG. 16) reads light reflected from LED 6A. Alternatively, document presence sensing can be accomplished with an interrupter circuit, wherein the presence of a document is registered when a light path between elements is interrupted.

As the check is drawn through the apparatus, the surface of the check reflects light back towards sensor 6 indicating that the check is present. The throat sensor signal is developed by sensor 6 when a document or check first enters the system. Importantly, as explained hereinafter, the optical sensor array 10 generates an analog video signal that goes high when the leading edge of a mechanically-conveyed check passes into field of view. As explained in detail later, this signal appears on node 648, in turn delivered to sample-and-hold circuit 649 (FIG. 16), which later develops a “document present” signal on line 610 (FIGS. 16-18).

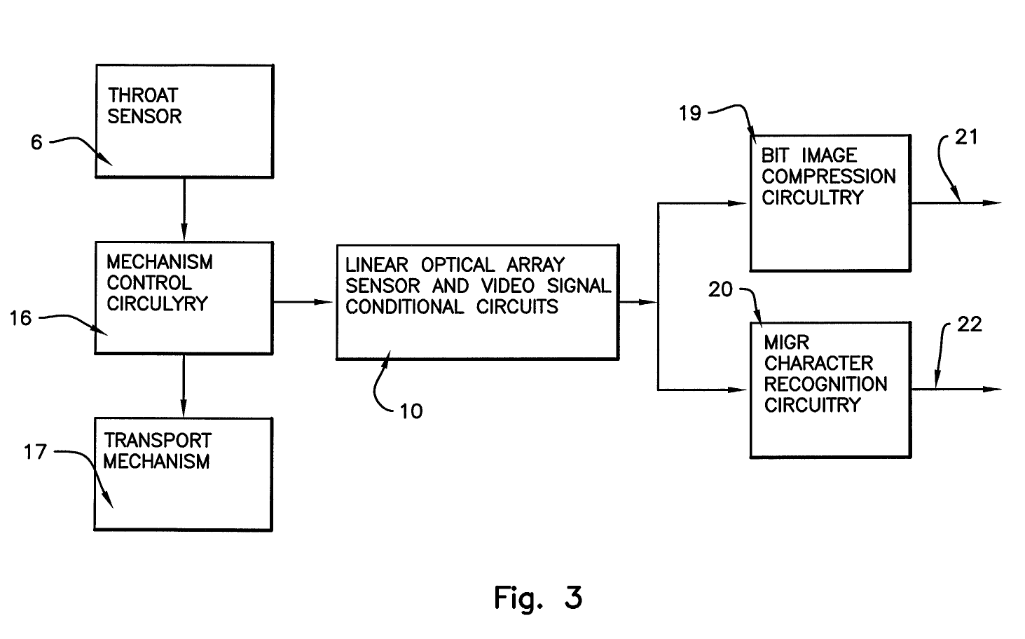

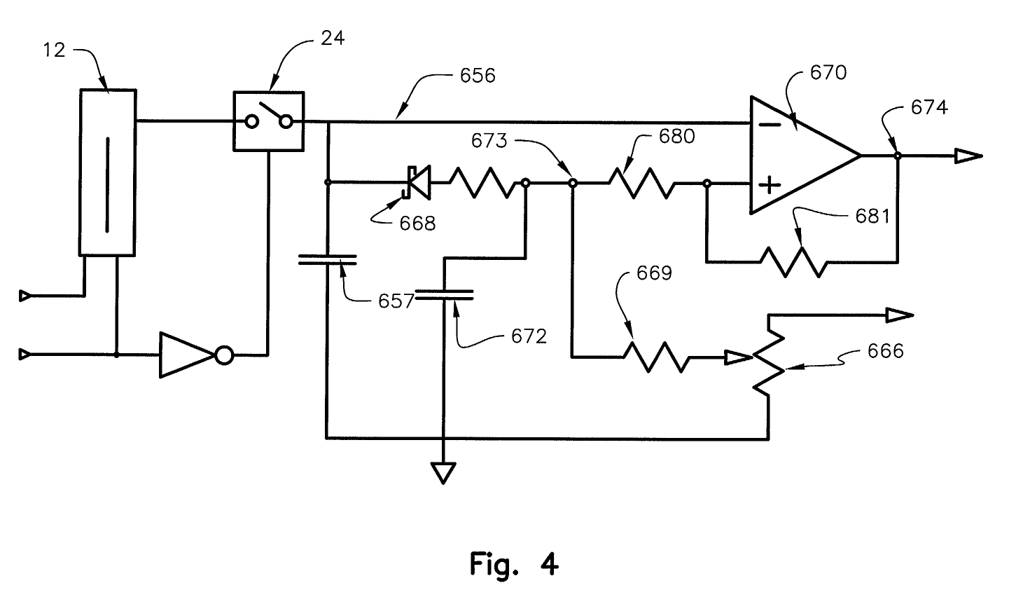

The optical throat sensor 6 (FIGS. 1, 3)) activates mechanism control circuitry 16 (FIG. 3) which generates an activation signal that controls transport mechanism 17. As a result, motor 1, gear drive 2, and drive hub 3 (FIG. 1) all rotate. When the check is inserted far enough into the transport mechanism, the leading edge of the check will be pinched between the back up rollers 5 and the drive hub 3. Thereafter, the check will be moved through the transport mechanism as the drive hub rotates, passing the light scanning apparatus detailed hereinafter. The transport mechanism is initially idle, with the motor stopped, until the presence of a check or document is sensed. When a check is inserted into the transport mechanism circuit 16 (FIG. 3) it first activates sensor 6, and thereafter generates a reset pulse and a shift clock signal (FIG. 4) that activate linear optical array sensor 10 (FIG. 1). Once sensor 10 is thus activated, its analog video signal on line 656 (FIGS. 4, 16) is transmitted to a pair of sample and hold circuits best illustrated in FIGS. 4, 16. Check presence is preferably confirmed by an interrupt detector that determines if the presence of a check interrupts light.

As check 4 moves through the transport mechanism, visible light source 9 and the infrared light source 8 will illuminate separate, distinct portions of the check surface. Light from these two sources is segregated at the check surface by an opaque light baffle 7 disposed between the light sources 8 and 9. A spaced-apart focusing lens 11 is interposed between the drive hub 3 and the sensor array 10. Lens 11 preferably comprises a SELFOC brand lens made by MSG America Inc. Light reflected from the surface of the check is presented by lens 11 as an unmagnified, erect image upon the linear optical sensor array 10. Array 10 preferably comprises a Taos brand model TSL 1410 linear optical sensor. FIG. 3 shows the electronic system block diagram for the check scanner/decoder.

Sensor 10, which functions as an analog shift register, outputs 1280 pixels per scan line. The pixel field is spaced at 400 pixels per inch. This permits the scanning of an image 3.200 inches high. The maximum height of a check is 3.660 inches. In the best mode the sensor does not scan the entire document (i.e., the complete height cannot be scanned using the preferred 1:1 lens system.) By minimizing the space scanned, memory and processing requirements are reduced. The device preferably scans only 3.200 inches of the check height. Scanning starts from the bottom of the MICR field region, which is 0.187 inches from the bottom edge of the check. This means that the prototype will not image the top 0.273 inches of a 3.660 inch high check. Since the top 0.125 inches of a check is devoted to a white border which does not contain any useful information, the prototype will fail to image only about 0.150 inches of information-containing surface on maximum-height checks.

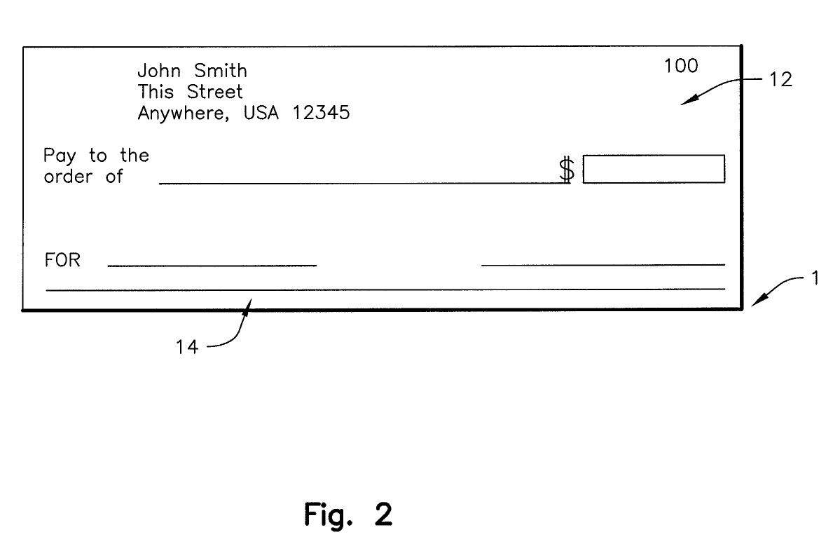

Importantly, two distinct and separate areas on each document or check to be scanned are illuminated by separate light sources. A narrow strip 14 (FIG. 2) preferably extends 0.4375 inches upwardly from bottom edge 13 of the document. According to standard convention and dimensional requirements known to those skilled in the art, check MICR characters must be contained within region 14, which is illuminated only by infrared light source 8. The remaining surface 12 of the check is illuminated only with the visible light source 9 (FIG. 1). Light baffle 7 (FIG. 1) is positioned so that visible light source 9 will not illuminate the check region 14 (i.e., the 0.4375 inch wide strip). Baffle 7 is made from opaque plastic, preferably fifteen thousandths of an inch think. Preferably the baffle is positioned approximately fifteen-thousands of an inch from the check. In the best mode the baffle occupies a horizontal plane substantially aligned with the top of MICR region 14 (FIG. 2). With the baffle constructed as aforesaid, infrared light source 8 cannot illuminate check surface portions that are outside narrow, lower strip 14.

When a customer fills out a check at the point of sale, it is entirely possible that portions of the signature or descriptive notes may descend into the MICR portion of the check. Such hand-written marks could make the MICR characters unidentifiable unless a way is found to separate the hand-written marks from the printed MICR characters. However, MICR ink absorbs infrared light, while the majority of inks used in ball point pens do not absorb infrared light. Therefore MICR characters are illuminated with infrared light, to insure that hand-written marks or ink smudges will not be visible to the sensor array 10.

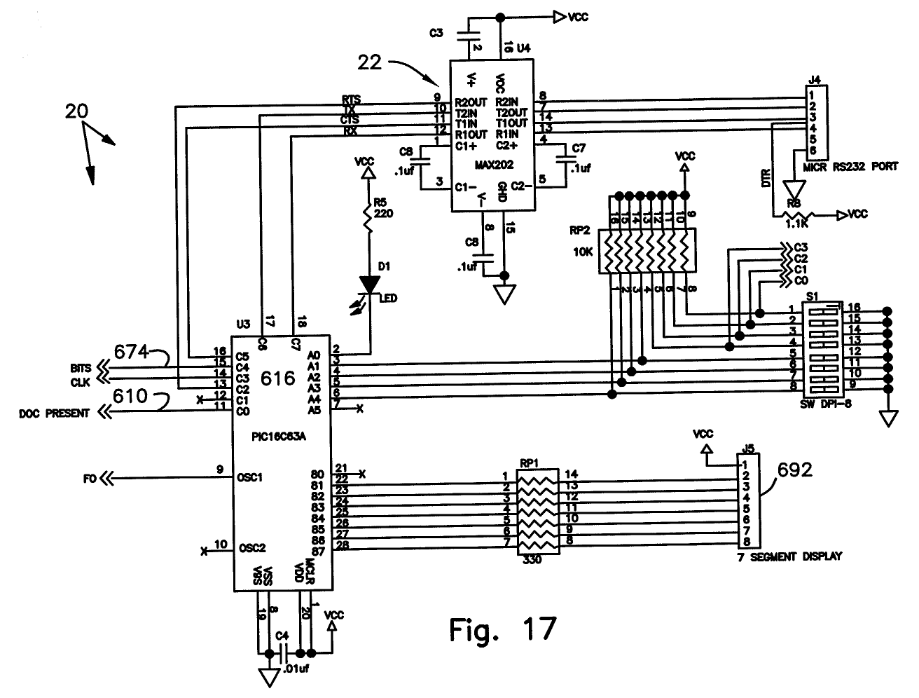

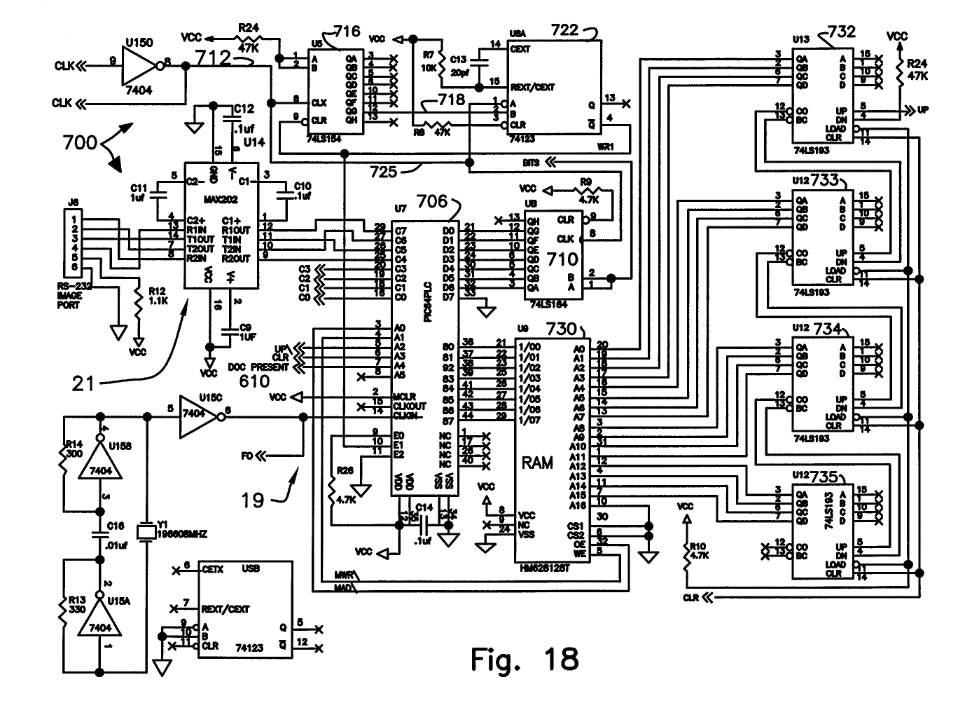

As the check moves through the transport mechanism, linear optical array sensor 10 generates an output signal representing a scan line of 1280 contiguous pixels. The preferred image sensor is a Taos model TSL 1410. This CCD linear image sensor array has 1280 pixels, spaced at 400 pixels per inch. In the preferred check reading mode, the microprocessor controller uses every pixel element from the sensor. Each pixel has a voltage amplitude proportional to the light intensity reflected from the surface of the check. Pixel samples are spaced at 400 pixels per vertical inch along the check surface. Text printed on the surface of the check absorbs incident light and thus reflects less light than unprinted portions. Printed portions of the check surface produce lower amplitude voltage signals. In other words, pixel signals derived from non-printed portions of the check surface have a stronger amplitude. As explained hereinafter, sensor 10 derives both bit image and MICR character data. Bit images are compressed in circuit 19 (FIGS. 3, 17) for transmission through RS-232 serial communications transceiver 21 (FIGS. 3, 18). MICR character data from MICR recognition circuitry 20 (FIGS. 3, 18) is similarly outputted through communications transceivers 22 (FIGS. 3, 17).

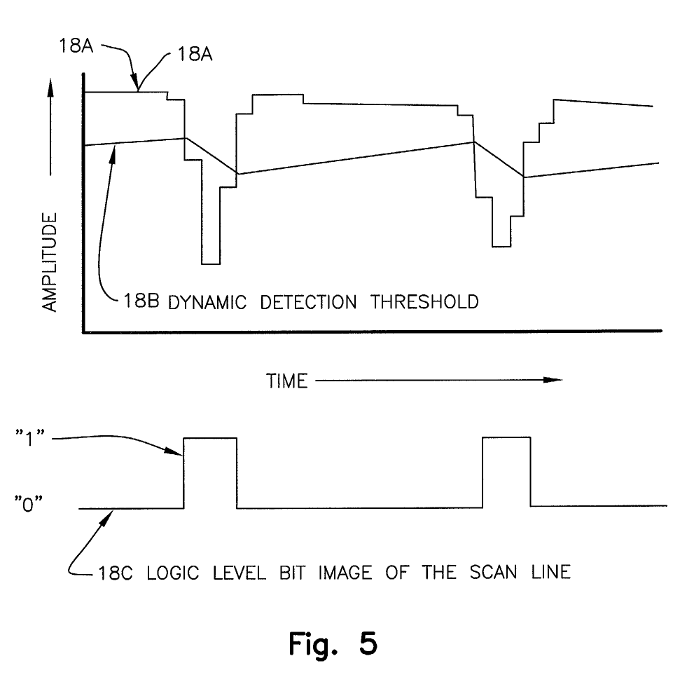

FIG. 5 shows contiguous pixel signals derived from the linear array sensor 10 as it scans across two black, horizontal lines. It is possible to determine where along the scan line the printed portions are located by comparing the average signal amplitude with the instantaneous signal amplitude. Those signals that are below the average amplitude represent printed portions of the scan and those signals above the average represent non-printed portions of the scan line. The average signal amplitude represented by trace 18A (FIG. 5) forms a “detection threshold” for discriminating between printed and non-printed portions of the scan line. The amount of light reflected from the surface of a check varies from check to check and from location to location on a given check. In order to compensate for these variations, an averaging filter is used. Trace 18B represents dips in reflected light intensity, corresponding to detected printed matter. When these dips occur, a logical one bit image is developed, as indicated by trace 18C.

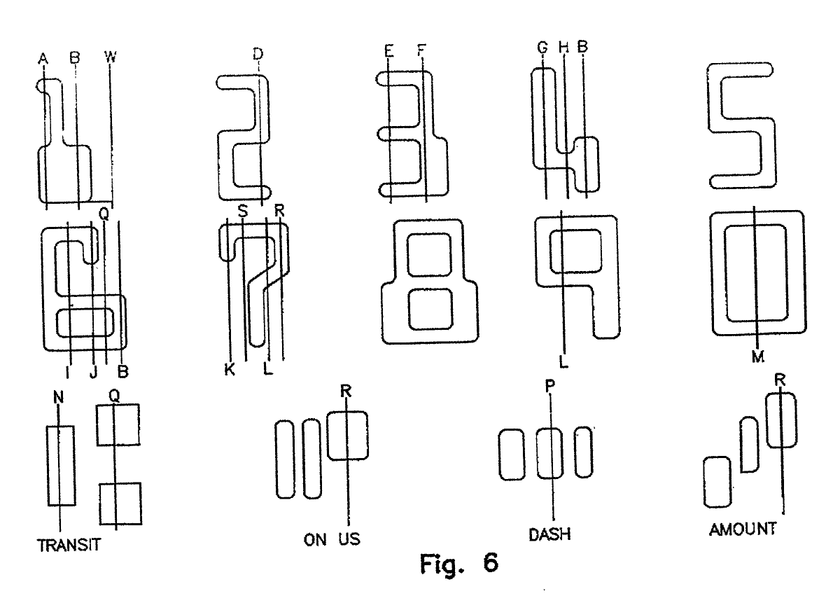

Typical MICR characters scanned by the apparatus are shown to scale in FIG. 6. The MICR characters were designed to be read both magnetically and optically. It will be appreciated that when MICR characters are displayed upon checks or documents, they will be solid black in color. While there are several ways that the MICR characters can be decoded optically, in accordance with the invention the preferred method requires a minimum amount of digital storage or memory.

The invention ultimately develops various digital sequences from successive vertical scans across pertinent portions of the check containing MICR characters. These scans are processed by detection logic to convert waveform 18A (FIG. 5) to logical ones and zeroes as in trace 18C (FIG. 5).

The industry standard specification governing the location of the E13B or MICR characters on a check requires that the E13B characters be printed within a field on the check that is 0.250 inches wide, located 0.1875 inches from the bottom edge of the check. The preferred optical array sensor has 400 photo sensors per linear inch, so the entire 0.250 inch vertical height of the E13B print field can be spanned by one hundred of the photo sensors. However, because of potential errors in printing, or the cut dimension of the check, or wear along the side of the check or the physical positioning errors of the check relative to the sensor array as the check is moved through the transport mechanism, it is recommended that the image processor sample more than one hundred pixels in order to ensure that the complete height of the E13B characters can be found. In the preferred embodiment, 117 pixels are sampled and delivered to the image processor.

The specification for the E13B font requires that the characters be printed with a vertical height of 0.117 inches. When the linear array sensor has 400 photosensitive elements per inch, a vertical height of an E13B character will be spanned by 46.8 of the photosensitive elements on the linear array. Depending on the exact registration of the image of the character on the linear array elements, the digital bit image of the character may activate 46 or 47 photosensitive elements. However, we are guaranteed that the full height of an E13B characters will be imaged by a contiguous set of not more than 48 elements at the sensor array.

In the best mode of our invention, the number of pixels (P) or raw bits to be used for properly representing a given MICR character is related to the hardware pixel density (D), and the size (S) of the MICR characters:

P=(D×S)+t,

where t=number of tolerance bits, preferably 1.

Thus at a density D of 400 bits per inch, a given MICR character of S=0.117 inches height, requires 46.8 pixels for a “perfect” character. With “tolerance,” 48 pixels are used for the complete character height, as a “tolerance bit (T=1) is added. The raw, 48 bit numbers are then compressed (i.e., “spatially filtered”) by generating subgroups that “overlap.” In other words, the 48 bit raw number (P=48) is to be transformed into M subgroups of N bits each, i.e., “intermediate” numbers. The number “M” is chosen from a variety of hardware and software considerations apparent to those with skill in the art. In the best mode M=8. Further, M=P/(N−2), where there are two padding bits as described hereinafter.

Spatial filtering occurs according to the method in Table 1:

TABLE 1
Spatial filtering

Step A:
Obtain a raw binary sequence of P bits (i.e., 48 bits in the best mode)
from each scan line. For example, obtain Scan “A”, which is to be
thereafter compressed:
011111111111111111111110000000000000000000011111
Step B
Convert each P-bit sequence of each scan by padding each end of the
number with a single zero bit, one on each end of the sequence,
yielding a P + 2 bit sequence: For example, scan “A” is
converted to the following:
00111111111111111111111100000000000000000000111110
Step C:
A quantity of M, N-bit numbers (i.e., preferably M = 8; N = 8)
are derived from each P + 2 bit number above by counting, from right
two left, N bits (i.e., eight bits) to make the first intermediate
number, and for successive intermediate numbers, backing up N/4 bits
(i.e., two bits) and then counting N (i.e., eight) successive digits to
the left ((P = M × (N − 2)):

00111110

00000000

00000000

00000000

11111100

11111111

11111111

00111111

Step D:
Derive resultant binary number by forming one-bit equivalences from each
intermediate number that has N/2 (i.e., four) contiguous “1 bits:”
1 1 1 1 0 0 0 1

In the best mode M=8, and N=8, as the sample “bytes” must be eight bits long in accordance with the hardware, i.e., eight bit registers. If, on the other hand, non-overlapping techniques were used, it would be possible, with the MICR font, for a group of N/2 or four contiguous bits to be broken up such that three of the “1 ” bits would appear in one group and the remaining “1 ” bit would appear in the next “byte” of six bits. This is a quirk of the MICR font system. By taking each group of six bits and including with it one bit from the left six bit group and one from the right six-bit byte, then all four contiguous “1's” are located within a single eight-bit sample.

This problem, which is solved by our invention, is caused by “boundaries” associated with MICR scanning. The six bit groups can occur on opposite “sides” of the desired, contiguous four “1's” in the scan. This is easy to explain for all characters that have a horizontal stroke at the middle of the character. These characters include the numbers 3 and 8. If said character is divided into eight vertical bands, then the boundary between band four and band five occurs in the middle of the horizontal stroke at the center of the character. The strokes are 0.0135 inches wide nominally. Sampling at 400 bits per inch yields a sample every 0.0025 inches, resulting in five 1 bits in the raw data sequence. Unfortunately, 2.5 of them will appear in band 4 and 2.5 of them will appear in band 5. Because must quantize the samples, the desired group of four bits will appear spread apart; i.e., the desired four bits may appear as three bits in one sample group, and as one bit in a successive sample group. Neither band has enough 1's by itself to force the recognition. But, by looking at a slightly larger area than the band in question we will see four 1s, and thus horizontal stroke of the MICR character is recognized.

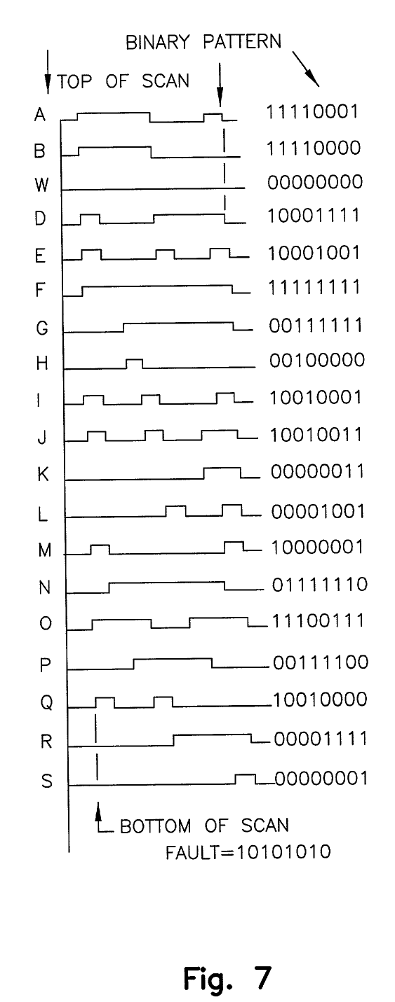

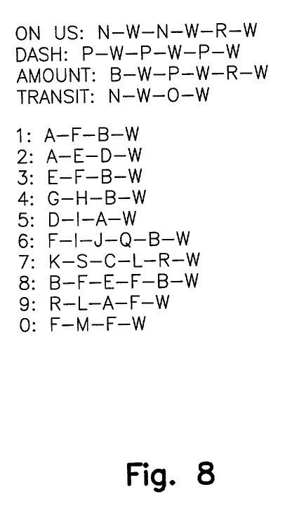

The raw, P-bit (i.e., preferably 48 bit) sequence from array 10 (starting Table 1, STEP A, above) and the compressed output comprises information to be transformed to M unique, N-bit intermediate numbers that are to be transformed to resultant numbers seen in the right half of FIG. 7 (i.e., they are referred to as scan line signals). These scans correspond to compressed scan patterns labeled A-S and W in FIGS. 6 and 7. Each of the scan lines designated diagrammatically A-S and W in FIG. 6 comprises a resultant number of one byte (i.e., a binary sequence of eight bits); each of these resultant numbers associated with each of the scans A-S and W (FIG. 7) is unique. Thus detection of each MICR character ultimately results in a unique combination of compressed scans A-S and W, as seen in FIG. 8.

According to the preferred spatial filtering method (Table 1), each single vertical scan derived along any path within or through a MICR character is transformed into M unique sequential, chronological segments. In step A., the raw P-bit (i.e., preferably 48 bit) sequence of a scan of a MICR “A” is derived from the linear optical array 10 (FIG. 1). In this instance hardware considerations dictate 8 bit numbers (N=8). The P-bit raw number is first padded, to yield P+2 bits. Thus in spatial filtering step B, the obtained 48 bit raw sequence is converted to a 50 bit binary number by padding. In spatial filtering step C (Table 1), M (i.e., preferably eight) unique M-bit (i.e., 8 bit) intermediate numbers are derived from sequential six-bit sequences of the P+2 bit number from step B; the 50 bit number of step B is converted into eight separate, eight-bit intermediate numbers, according to the formula: M=P/(N−2).

In step C, the M, M-bit numbers (i.e., preferably eight, 8-bit intermediate numbers) are derived from each P+2 bit number above by counting, from right two left, N bits (i.e., eight bits) to make the first intermediate number. For example, by counting 8 bits from the right of the 50 bit number obtained step B, the first binary intermediate number 00111110 is obtained. Successive intermediate numbers are made by backing up N/4 bits (i.e., two bits) after the first count, and then counting N (i.e., eight) successive digits to the left. The next intermediate number is thus 00000000. This repeats until M intermediate numbers, preferably eight, result.

Then in spatial filtering step D, a resultant M-bit number is created from the successive one bit equivalences of the M intermediate numbers. If N/2 (i.e., four) logical “1's” are found within an intermediate number, it is recorded as a logical “1.” If less than N/2 “ones” are found in a given intermediate number, it is converted to a logical “0”. In the best mode, the eight one-bit equivalences taken successively together yields an eight bit resultant number in Step D (Table 1). Each eight bit resultant number corresponds uniquely to a unique pattern; a combination of unique patterns corresponds to a given MICR number to be sensed. By using this method, wherein scan lines are taken from the bottom to the top of the MICR characters, all possible scan lines for the character set can be described by a unique logical sequence, which is translated through spatial filtering to the unique resultant number patterns shown in FIG. 7.

As an example, compressed scan line “A” in FIGS. 6 and 7 shows that when the scan is taken from bottom to top of the character there will be four, contiguous segments of logical “1” s followed by three contiguous segments of logical “0's” followed by a single segment of a logical “1”.

The purpose of the spatial filter is to compress the information contained in each raw 48 pixel scan over E13B characters into a single, unique eight-bit byte (i.e., corresponding to compressed scans A-S and W in FIG. 7). Under ideal conditions, the 48 digital bits that represent the white and black portions of a scan through a character would be the same every time. However, many imperfections and factors may corrupt the scan results, such that the 48 digital bits vary from the ideal. By way of example, corrupting factors result from small variations in the print quality or the light absorbing characteristics of the ink used to print the E13B characters, changes in the surface texture of the check, vertical movements documents passing through the transport mechanism, variations in the circuit components used in the signal conditioning circuitry, and/or electrical and optical noise in the system. Spatial filtering accommodates unwanted variations and produces an output signal that can be used by the character decoder. The output signal from the spatial filter is an eight bit ASCII byte corresponding to one of the compressed scan letters A-S and W shown in FIGS. 6 and 7 (or it is the special 8 bit byte assigned by the spatial filter to represent an unidentifiable scan.) When an unidentifiable scan is encountered the spatial filter outputs an 8 bit, binary byte with a 10101010 bit fault pattern (FIG. 7).

In the best mode, for each of the bits in the compressed eight-bit byte patterns of FIGS. 6 and 7, there is a corresponding set of eight bits in the original 48 taken from the uncompressed scan. The image processor will look at each of the corresponding sets of eight intermediate numbers, and based upon the bit pattern present in that set of eight bits, will determine if the set of eight bits represents a black mark or a white mark in the E13B character being scanned. If there are four or more, contiguous, black pixels in the an intermediate number then the image processor will declare the set to represent a black mark and set the corresponding bit in the 8 bit output byte to a logical 1. Otherwise, the image processor will set the corresponding bit in the eight bit output byte to a logical 0. In other words, if the present 48 bits represent a scan through an E13B character, then the result of spatial filtering will be an eight bit byte that matches one of those shown in FIG. 7.

Conceptually, the software described hereinafter breaks up the P+2 bit (i.e., 50 bit) string into eight, overlapping groups of eight bits each, according to Tables 1 and 2. Each of these overlapping groups is converted to a single bit; if four or more ones are detected in an overlapping group, it is assigned the value “1.” If three or less ones are detected, the value “0” is assigned, as illustrated at the bottom of Table 2.

TABLE 2
Spatial Filtering Results

| Intermediate Numbers | Spatial Filter Resultant Number |
|---|---|
| 00111111 | 1 |
| 11111111 | 1 |
| 11111111 | 1 |
| 11111111 | 1 |
| 00000000 | 0 |
| 00000000 | 0 |
| 00000000 | 0 |
| 00111110 | 1 |

When the spatial filter output bits are combined into a single 8 bit byte, in this example, the results are 11110001 (Table 2 right column) which corresponds to an “A” pattern (FIG. 7). Each resultant number (for example, Table 1, Sep D) is equivalenced with a particular pattern. Once the output from the spatial filter has been obtained, the resultant number is compared to the required patterns shown in FIG. 7, and if a match is found, the Get New Line Subroutine described later will replace the bit pattern from the spatial filter with the ASCII character (i.e., A-S, W as in FIGS. 6, 7) that it corresponds to. If no match is found then the Get New Line routine will replace the bit pattern from the spatial filter with a 10101010 bit pattern indicating an error. When a plurality of patterns are made from a sequence of scanning lines, the MICR character may be logically determined from the derived patterns.

As successive vertical scans are made substantially concurrently with horizontal check movement through the apparatus, a unique sequence of scan patterns A-S and W results. Each MICR symbol is characterized by a unique combination of said patterns, each derived from successive vertical scan sequences. For example, in FIG. 8 it is seen that the MICR character representing the numeral “1” is uniquely identified by four successive compressed patterns identified by the letters A, F, B and W. Compressed digital patterns respectively represented by the letters A, F, B and W are seen in FIG. 7. As mentioned earlier, these patterns result from compression of the 48-bit scans of the letter “structure” identified in FIG. 6. Derived sequences for the numerals 0-9 in the MICR character set are shown in FIG. 8, along with sequences for “Transit,” “on Us,” “Dash” and “Amount.” Thus every character in the MICR set can be decoded directly based on the sequence of compressed scan patterns. Scans between characters yield logical “0”s for all eight scan segments; this latter scan line is classified by the letter “W” corresponding to “White” space where nothing is found.

Thus all scans of check portion 14 result in an identifiable scan line of the type shown in FIGS. 6 and 7. The decoder needs to know only the sequence of scan line types within the character in order to decode the character. For example, the digit “1” has a type A pattern as the first non-white scan, followed by a type F pattern, a type B pattern, and another type W pattern. The last type W pattern indicates that the entire character has been scanned. The individual characters are be decoded with a decoder tree in which the program moves from state to state within the decode tree based on the classification of the next-arriving scan line or pattern. By using a decode tree, the program does not need to store any more data than is required to classify the present scan line into the required pattern.

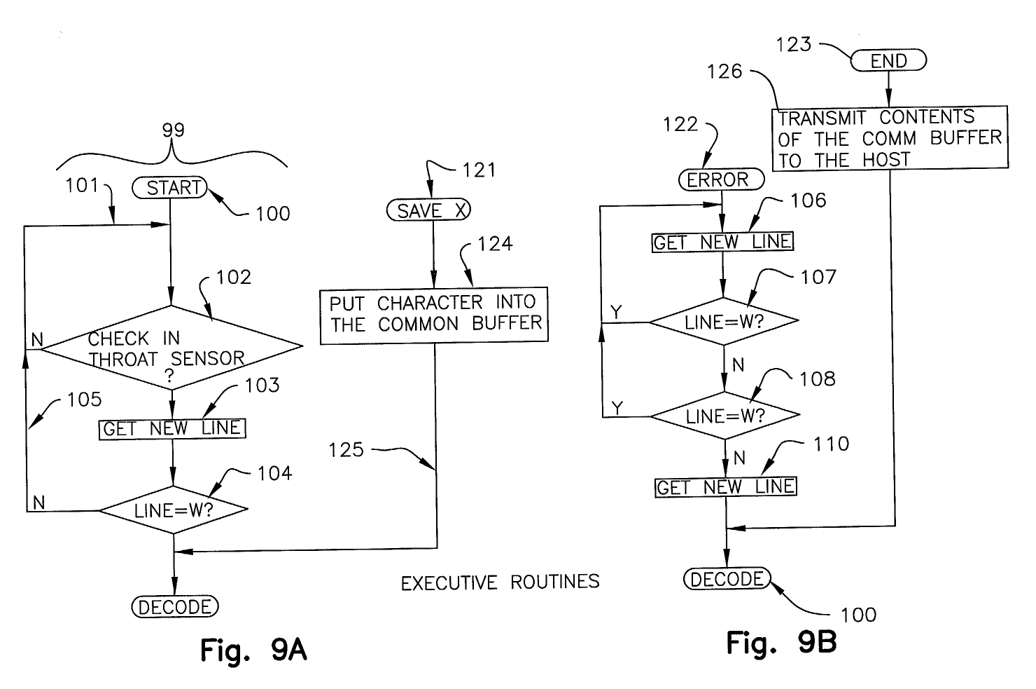

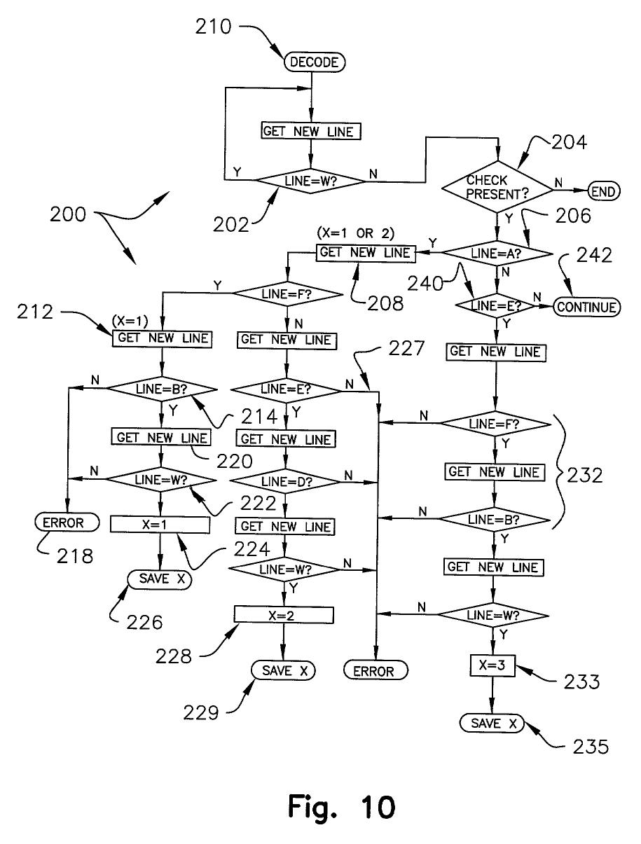

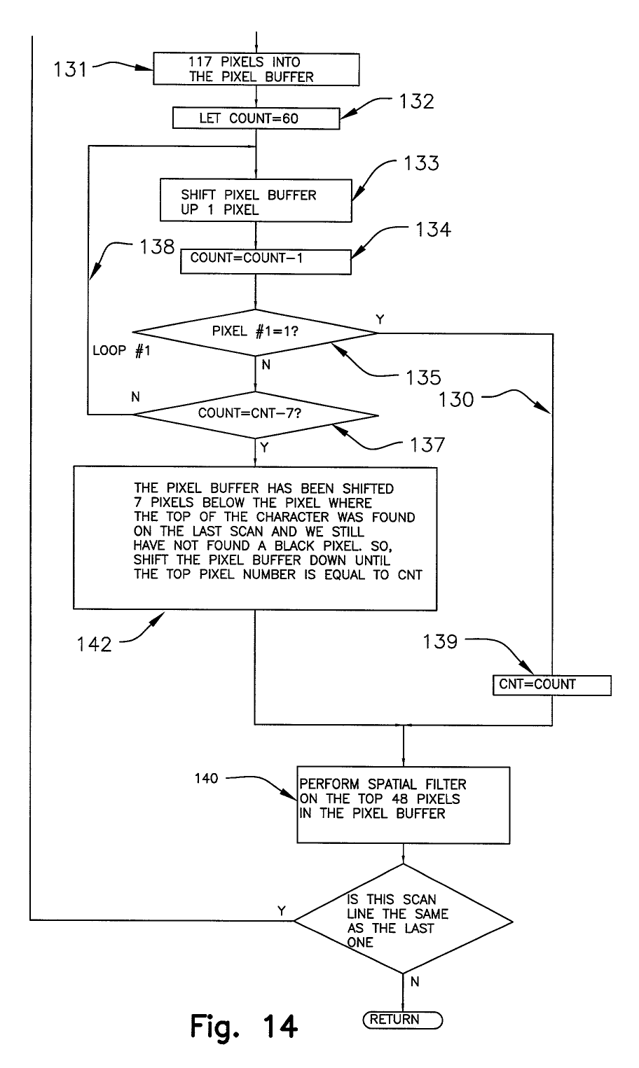

The complete character decoder algorithm is shown in flow chart form in FIGS. 9A, 9B and 10-15. The “Start” symbol 100 in FIG. 9A signifies the commencement of decoding by algorithm 99 (FIG. 9A). The presence of a signal from the throat sensor 6 (FIG. 1) is constantly monitored in step 102 to see if a check has been inserted into the transport mechanism. If no check is present, the throat sensor inquiry repeats, as indicated by loop 101. If a document inserted into the throat region has been detected, motor 1 is started as previously described, and the scanning process is initiated by scanning a new line, as in step 103. Step 103 executes the subroutine of FIG. 14, each time seeking to develop a recognizable “line” of the type shown in FIG. 6. When the leading edge of the check reaches the position where it is in view of the optical array sensor 10, the surface of the check will be scanned and the first white scan line will be detected. If the question is answered with a NO, the program repeats, as indicated by loop 105, and checks to make sure a check is in the machine. When the question “Line =W?” in step 104 is answered “YES”, the program will proceed to the Decode algorithm involving the software decoder subroutine 200 of FIGS. 10-13.

There are three paths 121, 122, 123 to return to the exec routine of FIGS. 9A, 9B from subroutine 200. These are respectively designated “Save X”, “error” and “end” in FIGS. 9A and 9B. If a legitimate MICR character has been decoded return is through the “save x” path 121, whereupon the character will be stored in step 124 (FIG. 9A) that outputs on line 125, and the decoder subroutine 200 (FIGS. 10-13) will be reexecuted. If subroutine 200 detects an error, then the decoder returns to error path 122 and executes subroutine 106 described below. The third possibility is that the end of the check has been reached, and in this case return to exec is through end path 123. Decoded MICR characters are transmitted via step 126 through the RS 232 port (FIG. 3) and a successful scan has been completed.

The error routine 106 (FIG. 9B) executes subroutine 130 (FIG. 14) and monitors the presence of a white line (i.e., step 107), and waits for the end of the check (i.e., step 108). Step 108 monitors the “document present” signal to be discussed later, seeking to find the physical end of the check. Routine 106 then presents the error code in step 110 to the user after which the program returns to the start step 110 and waits for another check to process.

The check is inserted into the transport mechanism is such a way that the left-most transit symbol will be the first MICR character decoded, resulting in the N-W-O-W sequence of codes detailed in FIG. 8. The program searches the scan line for the a sequence of six contiguous black segments that is preceded and followed by white segments (i.e., the “N” sequence of FIG. 7). The program then looks for a W scan to immediately follow the candidate N scan. If the W does not follow immediately then the program continues to look for the next candidate N scan. If a W scan does follow immediately, then the program looks for an O scan to immediately follow the W scan. Given that the O scan follows, the pixel location number of the top of the O scan is taken as the top of the print line. In subroutine 130 (FIG. 14) this pixel number is used as the reference for locating the top of the next scan line; however, small variations in the location of the print can be compensated for by making adjustments to this top pixel number.

The “Get New Line” subroutine 130 (FIG. 14) classifies scan lines according to the list of acceptable scans seen in FIG. 7. In the best mode known at this time, the optical array sensor 10 has 400 sensor elements per inch. Therefore the spacing between adjacent pixels is 0.0025 inches. The 0.250-inch high MICR code region 14 of the check is spanned by 100 pixels. The perfect MICR character is 0.117 inches high, requiring 46.8 pixels for a single scan line. To accommodate printing errors and variations in the location of the check as it moves through the transport mechanism, subroutine 130 seeks to determine a width corresponding to 48 pixels, which occurs with a properly dimension MICR character. In other words, the subroutine 130 needs to know where the MICR characters start. A string of 48 contiguous pixels is sought to determine check placement.

Only 100 pixels are needed to completely scan the MICR code region 14. But to provide a margin of error, a count of 117 pixels is obtained I step 131 (FIG. 14). Thereafter the program is looking for a black pixel in the top most portion of the buffer; either a black pixel is found, or 69 shifts are executed. A preset count of 69 pixels is established by step 132 (i.e., 117 minus 69 equals 48 pixels). In step 133 the pixel buffer is shifted up one pixel; in step 134 the count is decremented. Compare step 135 determines if the top pixel in the buffer is black. In step 137 if the count is nonzero a return on line 138 executes and the loop repeats until a black pixel is found. When a black pixel is detected by step 137, the program jumps to step 139 to set numeric variable CNT to the count value of step 134. CNT, the count that existed when a black pixel was found, is constantly adjusted to determine where the top pixel is. Spatial filtering step 140 can follow. At boot, i.e., initialization, CNT is initially set to zero.

Step 134 may decrement 69 times, and routine 130 may still not find a black pixel. If step 137 determines that pixel decrementing has occurred 69 times, shifting steps 142 (FIG. 14) are executed, leading to spatial filtering in block 140. Steps 142 add two extra pixels just to test for mechanical shifting of the check. It is expected that the top of the character somewhere within the first 69 pixels of the 117 pixel buffer will be lost. This system assumes that the top pixel of the MICR character is found at the same pixel count where it was found on the last scan. When a new check is presented, there is no history determining where the character is to be found within the 117 pixel buffer. If the first 69 pixels are referenced and no black pixel appears, the system could be processing a scan line within the character that does not have black at the top pixel. However, it is possible that a given check has been printed slightly improperly or that the edge of the check has been damaged (or moved vertically) such that the MICR field is physically located as much as two pixels lower than it should be.

To accommodate these circumstances two extra pixels below the 69th are read in subroutine 142. If a black mark is not found, then the buffer is shifted back to where bit 69 is at the top of the buffer. The system then processes the 48 pixels that are now at the top of the buffer. If a black pixel is found at bit 70 or 71 then the first black pixel of these two will be declared to be the top of the character.

If a black pixel is encountered before reaching the pixel count stored in “CNT,” it is assumed that the check has shifted up or the print is slanted, etc. “CNT” is updated to reflect the new top of character pixel number. If the pixel number in “CNT” is reached and a black pixel is still not located, the next seven pixels are reviewed just to make sure that the check did not slip down. If a black pixel is not found within the next seven, CNT is updated to reflect this fact.

This process allows for a position error of approximately +/−0.015 inches as the check moves through the mechanism. Of these 117 pixels, 48 contiguous pixels are isolated starting with either the first pixel with a black mark, or the pixel designated as the top of the character from a previous scan line. If the check moves upwardly as it moves through the mechanism the top pixel will also move upwardly. This upward movement will cause the first black pixel to be encountered before the top pixel count is reached as the scan line is read by the program. If this occurs, the top pixel count will be changed to match that where the first black pixel was encountered.

When the program reads the scan line, if the top pixel count is encountered before a black pixel then the program will read seven more pixels. If one of these additional pixels is black, then the program will adjust the top pixel count to be equal to that of the first black pixel. If neither of these additional pixels are black, then the top pixel count will not be changed. This will allow the program to track downward movements of the check as it moves through the mechanism.

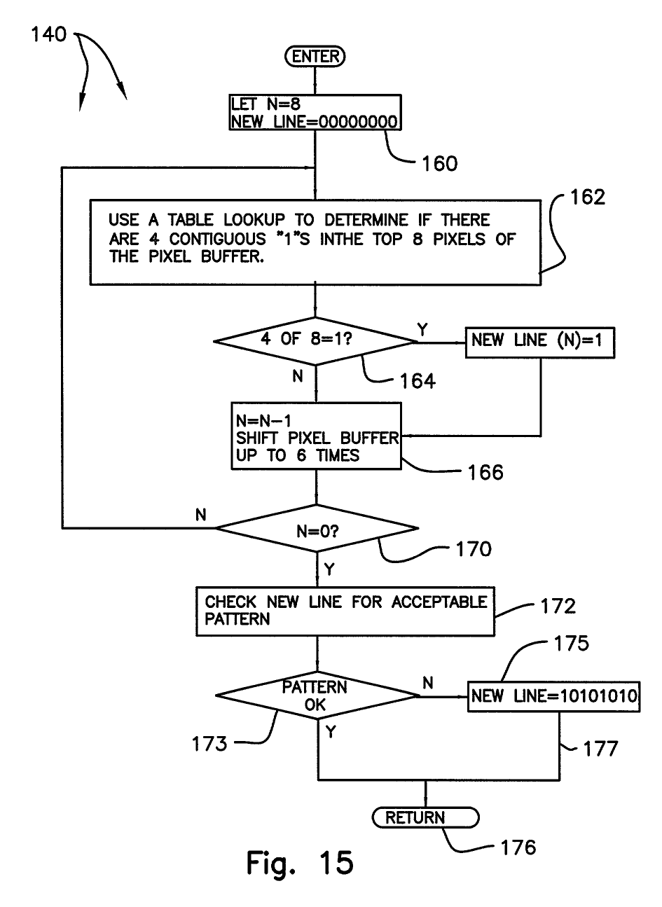

FIG. 15 depicts the preferred spatial filtering subroutine 140 in detail. This subroutine converts the 48 pixels that span the character height to a single 8-bit byte shown in FIG. 7. The filter operation is performed by dividing the 48 pixels into eight groups of eight contiguous pixels in step 160 (i.e., eight groups of eight bits). Of the numerous combinations of possible eight bit bytes, only those bytes comprising four or more contiguous bits (i.e., pixels) are “acceptable.” Only thirteen combinations of 256 possible eight bit combinations are acceptable to represent a “1” in the compressed, 8-bit form seen in FIG. 7. In this manner the eight bit patterns of FIG. 7 are obtained through spatial filtering of the 48 bits otherwise associated with 48 pixels.

During filtering, the 48 pixels from each scan line are analyzed as eight separate groups of eight pixels in the variable called “new line.” Steps 162 and 164 determine if at least four of the eight pixels within a group are logical 1's; if so, then the corresponding bit in the output byte will be set to a logical 1 in “New Line” step 165. Step 166 decrements the count; until all eight groups are analyzed a return is effectuated on line 170. After all eight groups have been checked and the corresponding bit in the output byte has been set to a logical 0 or a logical 1, the resulting 8 bit pattern is used as an index into a look up table in step 172 where the closest acceptable scan line pattern to the 8 bit pattern from the spatial filter is returned. The pattern from the look up table is used for analysis by the decoder.

The function “get new line” is different that the byte called “new line” as used in step 165. In this notation, “n” represents the bit number within the byte called “new line”. In step 160, a bit counter is initialized to eight and the byte “new line” is initialized so that all eight bits are set to “0” s. Then, in step 162, the 48 pixels in the line buffer are looked at in groups of eight contiguous bits. If four of the eight bits within a contiguous group are “1”s, then the group as a whole is declared to represent a black mark on the check and the corresponding bit in “new line” is set to a “1” in step 165. Regardless of the outcome of the investigation in step 162, the bit counter is decremented by 1 at step 166. If the bit counter has reached 0 in step 170 then the program will branch to step 172. Otherwise the program will loop back to step 162 and investigate the next group of bits.

After step 172, the bit pattern that was developed in the byte called “new line” will be checked in step 173 to see if it is a valid pattern by referencing a look-up table. Eight bits results in 32 possible combinations in the table. If the pattern in “new line” is an acceptable pattern, then the program returns at step 176 to the calling routine. Otherwise, the bit pattern in “new line” will be changed to 10101010 in step 175 (FIG. 15) to indicate that an unacceptable pattern has been found and then, the program will return to the calling routine. If the pattern in New Line step 165 is not acceptable, then it is replaced with a binary fault pattern of 10101010 and returns on line 177.

There are several ways to convert bit images of printed characters into their ASCII equivalent. One method is to do a pattern match. In the simplest embodiments of this method at least two “edges” of time character must be located as fixed reference points e.g. the left edge and the bottom edge of the character. Once these references have been established the pattern of bits within a rectangle sufficiently large to enclose the character is compared to known patterns for all characters that the device is designed to decode. The problem with this simple approach is that even small amounts of signal noise in the unknown bit image can result in a “no match found” result. It is possible to store a large collection of “altered” forms of the bit image but the memory requirements and the search times become unacceptable. Even with a large table of possible variations for each character there is still no guarantee that a match will always be found.

A better algorithm for identifying characters from their bit image is to look for identifying features that are indicative of specific characters or sets of characters e.g. the numerals 0, 4, 6, 8, and 9 all have at least one closed loop, while the numerals 1, 2, 3, 5, and 7 do not. By using closed loops to categorize the numerals, we can divide the 10 digits into two smaller sets. These smaller sets can farther be subdivided by looking for another identifying feature such as the presence of a horizontal or vertical line. The numeral 4 is the only digit that has both a horizontal and a vertical bar so, it can be identified by using only these two rules. This method can be extended by next looking for the presence of a slanted straight line segment or by considering the length of the horizontal line segments. It is not important what the identifying features are used as long as they result in a very low identification error rate.

It is clear from the above that if noise-free pixel data is available we know where the bottom of the character is located, then the MICR character can be classified into sets containing not more than two digits based on the very first scan line through the character. By looking at the MICR characters it is easy to see that as soon as the scanning process produces a new sequence of bits from the spatial filter the MICR character can be positively identified. This means that the decoder does not even need to look at the remainder of the character for anything other than to verify that the previous conclusion is correct.

The decode system identifies unknown MICR characters based on the sequence of patterns from the spatial filter. The decoder routine 200 (FIGS. 10-13) progresses after the physical location of the scanned check is insured as in FIGS. 9A, 9B, 14 and 15. Decoding continues until a non-white scan line (i.e., something other than a “Type W” scan) is encountered. If the scan line is not white and the check is still present then the program classifies the scan line as one of the allowable scan line types for the beginning of a character. The sequence of scan lines in FIG. 8 shows that the only allowable types for the first scan in a character are A, B, D, F, G, K, N, P and R. If the first scan line is not one of these an error has occurred and the program proceeds to the Error routine shown in FIG. 9B. The routine of FIG. 9b watches to see if a check has traversed the read station. The routine simply waits for the end of the check to pass the read station and then post the error code.

The decoding subroutine 200 is seen in FIGS. 10-13. It decodes the eight bit patterns of FIG. 7 that were obtained after spatial filtering. The decode step is entered from subroutine 99 (FIG. 9A). An ASCII character corresponding to the letters A-S and W in FIG. 7 is first obtained via step 201 by running the “Get New Line” subroutine of FIG. 14. If the first scan line type is one of those designating a start of a character, then the program branches to the segment where that character or set of characters can be decoded based on the designation of subsequent scan lines. If at any time the sequence of scan lines does not fit the required sequence, the program branches to the error routine 106 described above.

Steps 202 and 204 (FIG. 10) insure that a non-white scan is established and that a check is present. In step 206, if an “A” pattern (FIG. 6) is detected (i.e., the ASCII equivalent is read), another scan line is obtained in step 208. If that line is determined to be an “F” in step 210, a new line is sought via step 212, and the latter line must either comprise an ASCII “B” detected in step 214, or there is an error, as indicated by step 218. If a “B” scan line is detected in step 214, a new line is sought in step 220 and, if step 222 determines that it is a “W” pattern, X is set to 1 in step 224 and X is saved in step 226. The value “X” corresponds to the MICR digit that has been read. If step 222 does not reveal a “W” pattern, error step 218 occurs.

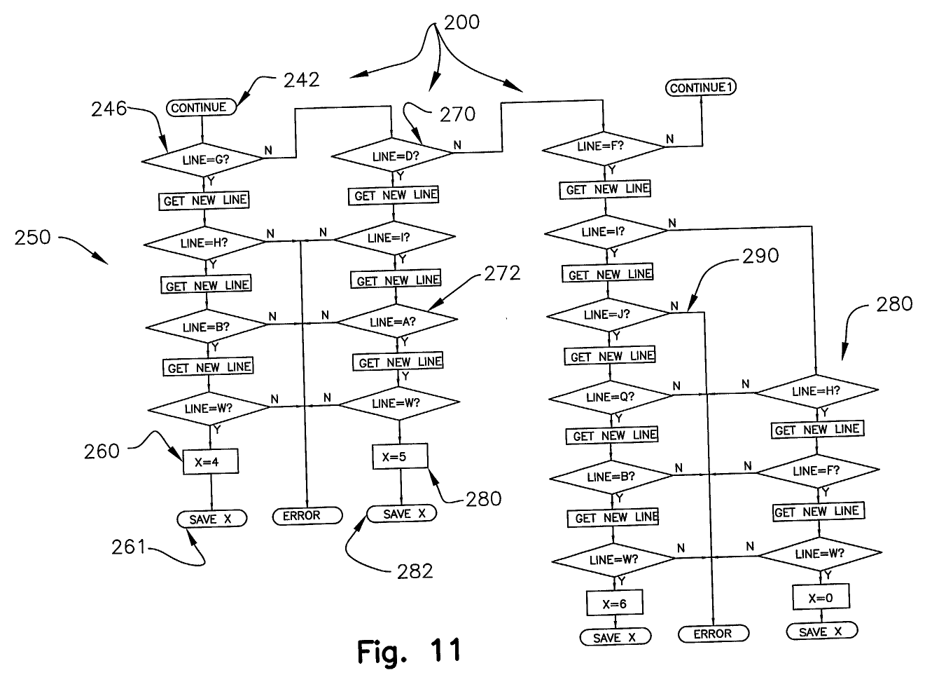

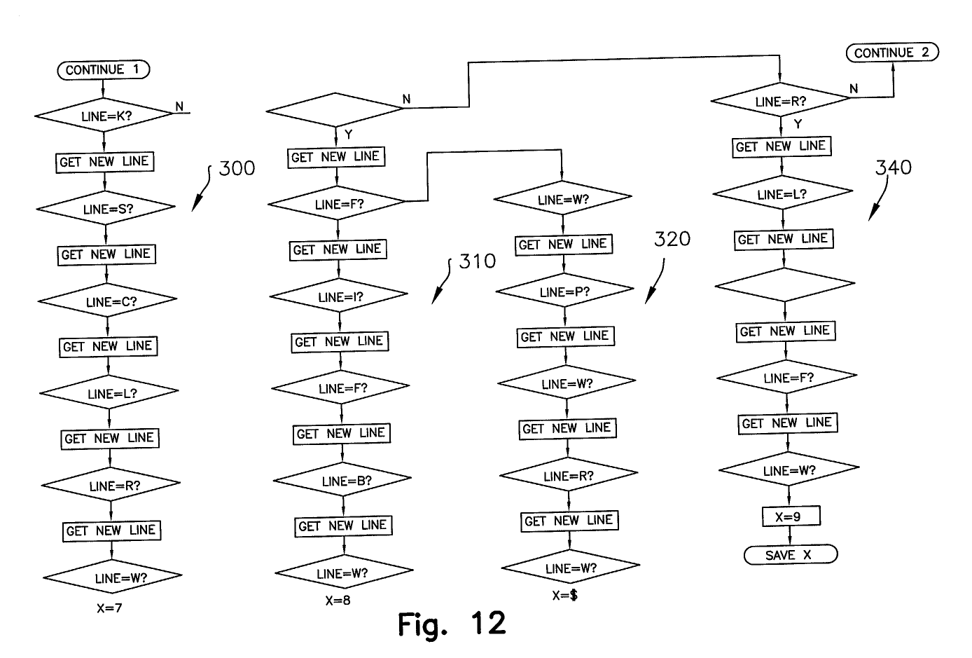

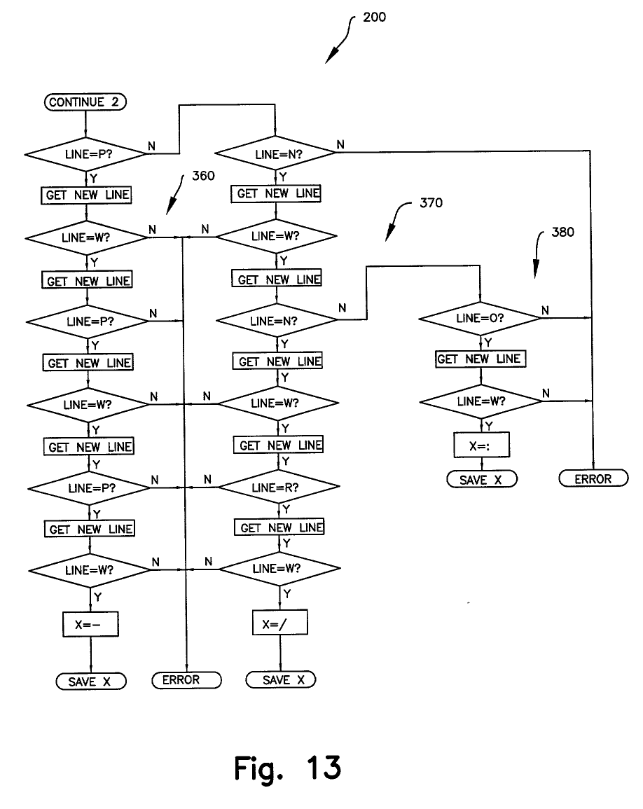

Decoder subroutine branch 227 (FIG. 10) similarly checks serially for the occurrence of certain patters as described in FIG. 8. It looks for an “I”, “D”, and “W” pattern. Variable X can be set in step 228 and saved in step 229. Similarly, if step 206 does not recognize an “A” pattern decoder subroutine branch 232 serially checks for “I”, “F”, “B”, and “W” patterns. Variable X can be set to “3” in step 233 (FIG. 10) and saved in step 235. Step 240 in subroutine 232 continues at 242 if an “I” pattern is not detected. Continuing on FIG. 11, the decoder algorithm 200 checks for a “G” pattern in step 246, and, if a “G” pattern is recognized, subroutine 250 determines if “H”, “B”, and “W” patterns exist. Again variable X can be set in step 260 and saved in step 261 as a MICR character “4”. If step 246 returns a “no” and step 270 recognizes a “D” pattern, subroutine serially checks for a an “I”, “A” and “W” patterns. Variable X can be set in step 280 to a MICR character “5” and it is saved in step 282. Similar decoder tree pattern recognition subroutines 290, 296 (FIG. 11), 300, 310, 320, and 340 (FIG. 12), and 360, 370, and 380 (FIG. 13) complete the MICR code recognition analysis.

As the MICR code decoder tree operates, bit images of the upper portions of the check are generated. They are received from signal conditioning circuitry and preferably compressed. These are obtained from the visible light scan of the upper portions of the check. Preferably, a compression algorithm compresses white space. The bit image is stored in eight bit bytes where the most significant bit is used as a flag and the lower seven bits comprise seven contiguous bits of the image or a count for repeated white. When the microprocessor 706 (FIG. 18) receives seven contiguous bits it tests to see if any of the seven bits are logical “1's” representing black marks on the surface of the check. If any of the seven bits are logical “1's,” they are stored in the lower bits of an eight-bit byte and the eighth bit is set to a logical “0”. If all seven of the bits are logical “0's” then a new byte will be generated in which the eighth bit is a logical “1” and the lower seven bits indicate the number of successive “all white” bytes (bits?) have been received. As soon as an all white byte has been received, immediately after receiving a byte with at least one “1” bit, then the white byte will cause the program to construct a control byte containing a logical “1” in bit eight and a logical “1” in bit one. This will indicate that one all white byte has been found. If the next byte is also all white, then the count in the control byte will be incremented by 1. This process will be continued until a byte containing a logic “1” is received at that time, the control byte will be stored in ram followed by the last byte then, the compression program will continue.

The first step in the image processing process it to locate the 48 pixels within the first 117 pixels of the scan line that represent the bit image of the E13B character. As later described, in the best mode the pixel number where the top of the E13B character image starts is recorded in the microprocessor memory as the Top of Character pixel number and this pixel number is used as a reference on the next scan. In order to simplify this search process, the image processor program makes the assumption that the pixel number within the set of 117 pixels where the Top of Character starts will be the same for successive scan lines. However, because vertical movement of the check can take place and/or the string of E13B characters may not be printed with perfect alignment relative to each other, it is possible that the top of the character may be in a slightly different vertical position on each successive optical scan. It is important that the top of the character be identified as accurately as possible so that successive image processing steps can proceed with a minimum possibility of making errors. To this end, the image processor makes tests to see if it a slight shift in the vertical position of the E13B characters has taken place. If a vertical shift in the location of the E13B characters can be identified then, the program will record the new number for the Top of Character pixel.

According to the invention, the image processor inputs the first 117 image bits from the sensor array 10 and stores them, in order, in memory. Then, the image processor scans the stored bits, in descending order, starting at bit 117. The image processor will scan the stored bits successively in this manner until either a black pixel is found or the previously recorded, Top of Character, pixel has been reached. If a black pixel is found first then, the number of that pixel is stored as the new Top of Character pixel and the program proceeds to the next phase of image processing.

If the Top of Character pixel is reached without encountering a black pixel then, there are two possible situations that must be investigated. It is possible that the check experienced a small downward vertical shift or, the top pixel in the present character scan is not a black pixel. In order to test for the first possibility, the image processor looks at the next six, lower numbered pixels in the pixel buffer in succession and if any of them is a black pixel then, the program assumes that a vertical shift of the check has taken place and changes the Top of Character pixel number to reflect the number of the pixel where the first black pixel was found then proceeds to the next phase of image processing. If none of the next six lower numbered pixels are black then, the image processor assumes that this is a scan through the character where the top pixel is not black. Under this last assumption the image processor does not alter the Top of Character pixel number and proceeds to the next phase of image processing.

The preferred software decoding method may be derived generally from U.S. Pat. No. 4,180,799 Issued Dec. 25, 1979, which is hereby incorporated by reference herein. The exact opposite problem to those discussed in conjunction with infrared MICR code reading is present everywhere else on the check, where handwriting needs to be detected. This includes the payee, the numerical and text dollar amounts and the signature. In order to make the handwriting visible to the sensor we must illuminate the check with visible light that will be absorbed by the ink.

Turning to the circuit hardware (FIGS. 4, 16-18), the aforedescribed computer programs are stored in the various microprocessors. The subroutines of FIGS. 9A, 9B and 10-15 are stored in microprocessor 616 of FIG. 17. The machine control microprocessor 600 (FIG. 16) is initialized when five volts is first applied. After initialization the program enters an idle loop waiting for a check to be inserted and detected as aforesaid. When a check is inserted, the light beam produced by an LED within sensor 6 (FIG. 1) that is connected via J2 and J3 (FIG. 16), is broken. Phototransistor 6B on the other side of the check, that is coupled to connector J3 (FIG. 16) generates a logical “1” signal on pin 2 of J3 when a check is not present. When a check reflects light from the LED, phototransistor 6B causes the signal at J3, pin 2 to go high indicating that a check is present. The signal on J3 pin 2 is presented to non-inverting buffer 602 (FIG. 16) via line 601. When a “0” is present on pin 11 of buffer 602, a logical “1” presented at pin 10 is outputted on line 606. This signal, hereinafter referred to as the “throat sensor signal,” is present on line 606 (FIG. 16). The signal appearing on line 610 (FIG. 16), hereinafter refereed to as the “Document Present” signal, is connected to the machine control microprocessor 600 at pin 10. The document present signal on line 610 also reaches the MICR decoder processor 616, at pin 11 (FIG. 17).

When the document present signal on line 610 goes high, machine control processor 600 begins executing its operational program. The operational program places a logical “1” on line 620 (FIG. 16) via pin 9. A high signal on line 620 turns on the motor drive HEX-FET power transistor Q1. When Q1 is “ON,” current flows from VCC on line 622 through current limiting resistors R3 and R23, out pin 1 on connector J1 to the transport drive motor 1 (FIG. 1). This current flows through the drive motor, into pin 2 on J1, and through Q1 to ground. In addition, current flows from VCC out J8 pin 1, through the infrared LED that illuminates the check surface and back into J8, pin 2 and through Q1. These actions cause the surface of the check to be illuminated and the transport mechanism to start moving the check.

The program generates a reset pulse for the linear sensor array followed by 1280 shift clocks. The reset pulse is generated by CPU 600 (FIG. 16) and applied at pin 7 to line 642. Line 642 connects to pins 2, 3, and 9 of the linear sensor array 10. The shift clock signal, CLK, applied to line 644 by CPU 600, is presented to the sensor array 10 at pins 4 and 10. As each shift clock is presented, the array sensor 10 presents the next sequential video pixel to read one pixel at a time. A data signal on line 646 is outputted from its pins 12 and 6. The video pixel signal on line 646, A0, is an analog signal with an amplitude proportional to the amount of light falling on a corresponding physical region of the check. The derived video pixel signal, A0, is presented at node 648 to the inputs of two bi-directional switches, 650 and 652 (FIG. 16). These bi-directional switches 650, 652, are switched ON and OFF by the CLK signal on line 644. When the CLK signal on line 644 is “I” (i.e., high) the bi-directional switches are ON and the A0 signal will appear at the output lines 656, 658 of the bi-directional switches 650, 652 respectively. At this time capacitors 657 and 659 (FIG. 16) are charged to the same value as A0 (i.e., node 648). The voltage on capacitor 659 is compared to a reference voltage on resistor 661 by comparitor 660; if the voltage on line 658 is higher than the voltage across resistor 661, line 610 goes high. When the voltage on line 658 is lower than the voltage across resistor 661, line 610 is shorted to ground by comparitor 660 (i.e., it goes low.)

The averaging filter and the discriminator circuitry are shown in FIGS. 4 and 16. As explained in detail later, the signal from sensor array 10 is sampled by sampling switch 24, removing any unwanted transients. The sampled signal is stored on capacitor 657 until the next sample is taken. This signal is presented to the “−” input of comparitor 670 where the signal amplitude is compared with the “average” signal amplitude that is present on the “+” input of the comparitor 670. The average signal amplitude is generated by the filter action of capacitor 672, and resistors 666, 669. The Shottkey diode 668 rapidly discharges capacitor 672 when the analog video signal from switch 650 drops below the voltage on capacitor 672. This provides a means for rapidly changing the signal voltage on capacitor 672 when printed text is present. When pixels for the non-printed portions of the check surface are present, the signal voltage on 672 will normally be larger than the signal voltage on line 656 and diode 668 will be reversed biased i.e., it will not conduct. Under this condition, the voltage on capacitor 672 will be allowed to rise slowly as it charges toward Vcc. The net result of these charge and discharge paths is to produce a signal across capacitor 672 that rapidly tracks the average signal from the array sensor 10 .

The output signal on line 674 (FIG. 16) from the voltage comparitor corresponds to trace 18C (FIG. 5). It is a logical “1” level when printed areas of the check surface are scanned; otherwise, the output signal is a logical “0”. Resistors 680, 681 provide positive feedback from the voltage comparitor output generating a small amount of hysterisis in the detection threshold. This hysterisis causes the output signal to switch rapidly from and to remain in the new state even in the presence of small amounts of noise, that can otherwise affect the detection threshold.

Thus line 656 (FIGS. 4, 16) has the instantaneous sampled video signal 18B (FIG. 5). Node 673 has the averaged signal 18C seen in FIG. 5. The latter two signals are applied to comparitor 670 to obtain a clean digital signal 18C (FIG. 5) on BITS line 674.

When the A0 signal at node 648 is applied to line 658 and comparitor 660 (FIG. 16), capacitor C19 charges to the amplitude of signal A0. A reference voltage is generated by the resistor divider network comprising R22 and R21. This reference voltage is presented to the “−” input of comparitor 660; the A0 signal stored on C19 is concurrently presented to the “+” input of the comparitor 660. As long as a check is present at the read station in the transport mechanism, the A0 signal will be more positive than the reference, causing comparitor 660 to output a logical “1” signal via pin 7 to line 610. The output signal from comparitor 660 appearing on line 610 is the “throat” sensor signal, which is delivered to the circuits of FIGS. 17 and 18 to synchronize them. The machine control microprocessor 600 will continue to execute the operational program until the document present signal goes false i.e., back to a logic “0”. When the document present signal goes low the microprocessor will return program control to the idle state.

The A0 signal at the input of bi-directional switch 650 (FIG. 16) will be stored on capacitor C18 when the CLK signal on line 656 is high. This signal is presented to comparitor 670. The signal on pin 5 of comparitor 670 will be compared to the filtered signal from R/C network 671 (FIG. 16) on node 673 transmitted to pin 4 of comparitor 670. The signal on line 656 goes low when a black mark on the check is focused on the pixel being sampled. When a valid black mark is being sampled, the signal on line 656 will be less than the filtered signal at pin 4. When this happens the output of the comparitor on line 674 from pin 12 (BITS) will go to a logical “1.” Otherwise the output at pin 12 will be at a logic “0” level. Comparitor 670 thus produces a “1 ” output level on line 674 whenever a black pixel is being sampled. This BITS signal on line 674 is the bit image data that will be processed by the remaining two microprocessors.

With joint reference to FIGS. 5 and 16, the threshold voltage 18A is developed across node 673. This threshold detection circuit averages negative peaks; Vcc is developed across capacitor 672 through resistor 669. Voltage at node 673 discharges through diode 668. The analog video signal 18B (FIG. 5) appears on line 656 (FIG. 16). The output of comparitor 670 goes to a logical “1” (i.e., high) whenever a signal that is more negative than the average (i.e. trace 18A in FIG. 5) occurs. Th serial data BITS signal on line 674 comprises data scanned from the MICR region 14 of the check followed by data scanned from the visible light portion.

Referring to FIG. 17, the document present signal appearing on line 610 reaches MICR decoder processor 616. Until the document present signal goes high, this microprocessor 616 is idle. The microprocessor executes the operational program when line 610 goes high. The BITS signal and the CLK signal are connected to the data and clock inputs of the synchronous serial port in microprocessor 616. The synchronous serial port will shift in eight bits and then the operational program will read those eight bits as a single byte and store it in internal RAM. The operational program will only read in the first 13 bytes (104 bits) and ignore all subsequent bits.

The linear array sensor 10 (FIG. 1) is preferably mounted such that when the scan line data is shifted out, the first bits to arrive will be those from the bottom edge of the check. In addition, the sensor 10 is mounted so that the first pixel scanned is 0.005 inches below the MICR field. Since the pixel density is 400 dpi, 100 pixels corresponds to a linear distance of 0.250 inches. Because of the physical mounting and the pixel density, the first 104 pixels scans the space on the check from 0.005″ below the MICR field to 0.005″ above the MICR field. With this arrangement the entire MICR field is scanned, even with of vertical positioning errors of −0.005 inches to +0.025 inches. After 117 pixels (17 bytes) have been read and stored, the operational program executes the decode algorithm which is described elsewhere.

Decoder processor 616 (FIG. 17) continues to execute the program until the document present signal on line 610 goes low, indicating that the entire check has been scanned and decoded. Then, the operational program transmits the decoded MICR characters to the host via the RS-232 serial port. The logic level serial data for the host is converted to RS-232 levels by bi-directional transceiver 22, and the RS-232 level signals are connected to the host via J4 (FIG. 17). In the event that an error was detected while decoding the MICR characters, the error condition number will be presented to the seven segment display 692 (FIG. 17).

The bit image processing circuit 700 (FIG. 18) comprises image processor 706. The function of processor 706 is to accept the digital video signal, BITS, from the signal conditioning circuitry, compress it, and then store the compressed bit image in SRAM. Then it transmits the bit image to the host.

The largest check that can be scanned is 8.750 inches by 3.667 inches. But, the top 0.120″ and the bottom 0.187″ need not be scanned. Failure to scan the last 0.150 inches along the length of the check will not loose any required data. Therefore the scanned area is 8.600 inches by 3.355 inches. A scanning density of 400 pixels per inch in both directions yields 4,616,480 pixels. If this check is stored in 7 bit bytes, it will require 659,497 bytes to store the entire check. If the compression algorithm is efficient this can be compressed to not more than 10% or 65.95K bytes. It is anticipated that a simple run length code can compress the data to 5% of the original for most checks. In this circuit we have provided for 65.536K bytes of storage. This is more than enough to store the worst case image if we can compress to not more than 9% of the original.

The BITS signal on line 674 (FIG. 16) is presented to a serial-in, parallel-out shift register 710. The CLK signal on line 712 shifts the BITS signal into register 710. At the same time, the CLK signal shifts a logical “1” into a second, serial-in, parallel-out shift register 716. After seven shift clocks have been presented to register 716, it will output from it's pin 12 on line 718, leading to the trigger input of a one-shot multivibrator 722, generating a short pulse. The pulse from the multivibrator 722 on line 725 strobes the data bits setting in shift registers 710, 716. The one-shot pulse clears shift register 716 setting all of its bits to “0”. Once the 7 bits of bit image data have been strobed into the microprocessor, the operational program will compress them and store them in static RAM chip 730 (FIG. 18). The address for the static RAM is provided by the binary counters 732-735. These counters are controlled by the microprocessor via the signals CLR and UP. After the entire image has been stored, microprocessor 706 waits for a command from the host, and then begins transmitting the compressed bit image file to the host via the RS-232 transceiver 21 . After transmission the program will erase the RAM then, return to the idle state where it waits for a new byte to store. The primary purpose of the RAM is to store the bit image of the check until it can be transmitted to the host. It is not possible to transmit the bit image to the host as fast as it is being generated over RS-232 communications cables. This means that the bit image is best stored while it is being generated, and it is transmitted later.

From the foregoing, it will be seen that this invention is one well adapted to obtain all the ends and objects herein set forth, together with other advantages which are inherent to the structure.

It will be understood that certain features and subcombinations are of utility and may be employed without reference to other features and subcombinations. This is contemplated by and is within the scope of the claims.

As many possible embodiments may be made of the invention without departing from the scope thereof, it is to be understood that all matter herein set forth or shown in the accompanying drawings is to be interpreted as illustrative and not in a limiting sense.

What is claimed is:

1. A scanning system for decoding and reading checks or other documents comprising a region containing precoded characters and a separate region containing other indicia, said system comprising:
an input throat for admitting a check or other document into the system;
a drive motor;
check presence means for activating said motor and said system when a check or other document to be scanned is present in said throat;
means driven by said motor for drawing checks or other documents from said throat and moving them through the system for scanning;
infrared means for illuminating that region of the check containing the precoded characters with infrared light;
visible light means for concurrently illuminating said separate region with visible light;
sensor means for scanning the check as it moves though the system, said sensor concurrently reading visible and infrared light reflected from the check's surface to concurrently generate a bit images and character data;
means for decoding the character data to read the precoded characters; and,
means for concurrently generating a visible image of the check or document being scanned by decoding said bit image.

2. The system as defined in claim 1 wherein said check presence means comprises means for transmitting light towards said check, means for responding to the presence or absence of said light, and means for activating said motor and said optical sensor if a check is present.

3. The system as defined in claim 1 further comprising a baffle disposed between said infrared means and said visible light means for separating infrared light from visible light.

4. The system as defined in claim 3 further comprising a focusing lens interposed between the drive hub and the linear optical sensor.

5. The system as defined in claim 1 wherein said means sensor means generates a plurality of vertical scan lines.

6. The system as defined in claim 5 wherein said sensor means generates an output scan line of contiguous pixels, wherein each pixel has a voltage amplitude proportional to the light intensity reflected from the surface of the check.

7. The system as defined in claim 6 wherein each scan line comprises 1280 pixels, at 400 pixels per inch.

8. The system as defined in claim 1 further comprising means for compressing said bit images, and means for transmitting the compressed bit images through serial communications.

9. The system as defined in claim 1 further comprising video signal conditioning means for processing signals outputted by said sensor means, said video signal conditioning means determining where along each scan line that printed portions of said check or other document are located by comparing the average signal amplitude with the instantaneous signal amplitude.

10. The system as defined in claim 9 wherein said video signal conditioning means establishes a detection threshold for discriminating between printed and non-printed portions of the scan line, whereby signals that are below the average amplitude represent printed portions of the check or other document in a given scan line, and those signals above the average in a given scan line represent non-printed portions of the scan line.,

11. The system as defined in claim 1 wherein said means for decoding the character data to read the precoded characters comprises means for separating binary sequences corresponding to character data from each scan.

12. The system as defined in claim 1 further comprising spatial filtering means comprising:
means for recognizing a binary sequence corresponding to raw character data from each of a plurality of raw scans;
means for padding each recognized sequence by adding a binary bit at the left and right side of each raw binary sequence, thereby creating a padded binary number;
means for creating M intermediate N-bit numbers from each padded binary number;
means for creating a unique 1 bit representation of each intermediate number by assigning the value “1 ” to said intermediate numbers if they comprise N/2 or more “1's” in any place and/or assigning a value “0” if that intermediate number comprises less than N/2 “1's,”;
means for forming a resultant M-bit number from the M, 1-bit equivalences of the intermediate numbers;
means for comparing the resultant number to a table of patterns corresponding to possible scanning results, and correlating a series of patterns to recognize the character that has been scanned.

13. The system as defined in claim 12 wherein said means for concurrently generating a visible image of the check or document being scanned comprises means for first locating the pixels within the scan line that represent the bit image of the first character being read, buffer means for storing them, and means for then scanning the stored bits in descending order starting until either a black pixel is found or a previously recorded “Top of Character” pixel has been reached.

14. The system as defined in claim 13 further comprising means for correcting for vertical displacements of the check or document being scanned, said last mentioned means comprising means for looking at a plurality of successive, lower numbered pixels in the pixel buffer means in succession and, if any of them is a black pixel, changing the Top of Character pixel number to reflect the number of the pixel where the first black pixel was found.

15. The system as defined in claim 14 further comprising means for looking at the next plurality of successive, lower numbered pixels in the pixel buffer means after a black has been found, and, if none of the next six lower numbered pixels are black, then proceeding to the next phase of image processing.

16. A scanning system for decoding and reading checks or other documents comprising a region containing precoded MICR characters and a separate region containing other indicia, said system comprising:
an input throat for admitting a check or other document into the system;
a drive motor;
check presence means for activating said system and said motor when a check or other document to be scanned is present;
means driven by said motor for drawing checks or other documents from said throat and moving them through the system for scanning;
infrared means for illuminating that region of the check containing the MICR characters with infrared light;
visible light means for concurrently illuminating a separate portion of the check with visible light;
a linear optical sensor for scanning the check as it moves though the system, said sensor concurrently reading visible and infrared light reflected from the check's surface to concurrently generate MICR character data and a bit image data corresponding to the separate portion of the check;
means for decoding the MICR character data to read the precoded characters; and,
means for concurrently generating a visible image of the check or document being scanned by decoding said bit image.

17. The system as defined in claim 16 further comprising a baffle disposed between said infrared means and said visible light means for separating infrared light from visible light.

18. The system as defined in claim 17 further comprising a focusing lens interposed between the drive hub and the linear optical sensor.

19. The system as defined in claim 16 wherein the linear optical sensor generates a plurality of vertical scan lines comprising contiguous pixels comprising MICR character data and a bit image data, and wherein each pixel has a voltage amplitude proportional to the light intensity reflected from the surface of the check.

20. The system as defined in claim 19 wherein each scan line comprises 1280 pixels, at 400 pixels per inch.

21. The system as defined in claim 19 further comprising video signal conditioning means for processing signals outputted by said linear optical sensor, said video signal conditioning means determining where along each scan line that printed portions of said check or other document are located by comparing the average signal amplitude with the instantaneous signal amplitude.

22. The system as defined in claim 21 wherein said video signal conditioning means establishes a detection threshold for discriminating between printed and non-printed portions of the scan line, whereby signals that are below the average amplitude represent printed portions of the check or other document in a given scan line, and those signals above the average in a given scan line represent non-printed portions of the scan line.

23. The system as defined in claim 16 wherein said means for decoding preprinted character data comprises means for separating binary sequences from vertical scans across pertinent portions of characters.

24. The system as defined in claim 16 further comprising means for first generating a P-bit binary number corresponding to a trace of a MICR character, according to the formula:
P=(D×S)+t,
where D is the pixel density, S is the height of a MICR character being read, and t=a number of added tolerance bits.

25. The system as defined in claim 24 further comprising spatial filtering means comprising:
means for recognizing and then padding the P-bit number to convert it to a P+2 bit number;
means for creating M intermediate N-bit numbers from each padded P+2 bit binary number, where M=P/(N−2);
means for creating a unique 1 bit representation of each intermediate number by assigning the value “1” to said intermediate numbers if they comprise a N/2 or more “1's” in any place and/or assigning a value “0” of that intermediate number comprises less than N/2 binary “1's;”
means for forming an M-bit resultant number from the M, 1-bit equivalences of the intermediate numbers; and,
means for comparing the resultant number to a table of patterns corresponding to possible scanning results to obtain the character that has been scanned.

26. A scanning and reading system for decoding MICR characters on checks or other documents, said system comprising:
an input throat for admitting a check or other document into the system;
a drive motor;
check presence means for activating said system when a check is present;
a hub driven by said motor for drawing checks or other documents from said throat and moving them through the system for scanning;
infrared means for illuminating that region of the check containing the MICR characters with infrared light;
a linear optical sensor for scanning the check as it moves though the system, said sensor reading infrared light reflected from the check's surface to generate MICR character data;
means for decoding the MICR character data to read the precoded characters, said last mentioned means comprising means for generating a plurality of vertical scan lines comprising contiguous pixels and means for generating patterns from a plurality of scan lines to read a MICR character.

27. The system as defined in claim 26 further comprising a focusing lens interposed between the drive hub and the linear optical sensor.

28. The system as defined in claim 26 wherein the system comprises:
spatial filtering means comprising:
means for separating a P-bit binary sequence corresponding to raw character data from each of a plurality of raw scans;
means for padding each P-bit sequence by adding a binary bit at the left and right side of each raw binary sequence, thereby creating a padded P+2 bit binary number;
means for creating M intermediate N-bit numbers from each padded binary number, where M=P/(N−2);
means for creating a unique 1 bit equivalence of each intermediate number by assigning the value “1” to said intermediate numbers if they comprise N/2 or more “1's” in any place and/or assigning a value “0” if that intermediate number comprises less than N/2 “1's,”;
means for forming a resultant M-bit number from the M, 1-bit equivalences of the intermediate numbers;
means for comparing the resultant number to a table of patterns corresponding to possible scanning results; and,
means for correlating a series of patterns to recognize the character that has been scanned.

29. The system as defined in claim 26 further comprising means for first generating a P-bit binary number corresponding to a trace of a MICR character, according to the formula:
P=(D×S)+t,
where D is the pixel density, S is the height of a MICR character being read, and t=a number of added tolerance bits.

30. The system as defined in claim 29 wherein the spatial filtering means comprises:
means for padding said P-bit binary number corresponding to a trace of a MICR character by adding a binary bit at the left and right side of each raw binary sequence, thereby creating a padded P+2 bit binary number;
means for creating M intermediate, N-bit numbers from each padded binary number;
means for creating a unique 1 bit equivalence of each intermediate number by assigning the value “1” to said intermediate numbers if they comprise N/2 or more “1's” in any place and/or assigning a value “0” if that intermediate number comprises less than N/2 “1's,”;
means for forming a resultant M-bit number from the M, 1-bit equivalences of the intermediate numbers;
means for comparing the resultant number to a table of patterns corresponding to possible scanning results; and,
means for correlating a series of patterns to recognize the character that has been scanned.

31. A method for decoding and reading checks or other documents comprising a region containing precoded characters and a separate region containing other indicia, said method comprising:
illuminating that region of the check containing the precoded characters with infrared light;
concurrently illuminating said separate region with visible light;
scanning the moving check or other document by concurrently reading visible and infrared light reflected from the check's surface, thereby generating a plurality of scan lines each comprising pixels representing bit image information and pixels representing character data information;
decoding the character data information to read the precoded characters; and,
concurrently generating a visible image of the check or document being scanned by decoding said bit image information.

32. The method as defined in claim 31 further comprising the step of separating infrared light from said visible light.

33. The method as defined in claim 32 wherein each scan line comprises 1280 pixels, at 400 pixels per inch.

34. The method as defined in claim 31 further comprising the steps of separating those pixels in each scanning line that are generated from said precoded characters and generating a P-bit binary number corresponding to a trace of a character from said pixels in each scanning line that are generated from said precoded characters according to the formula:
P=(D×S)+t,
where D is the pixel density, S is the height of a MICR character being read, and t is a preselected number of added tolerance bits.

35. The method as defined in claim 31 wherein said scanning step comprises the further step of determining where along each scan line that printed portions of said check or other document are located by comparing the average signal amplitude with the instantaneous signal amplitude.

36. The method as defined in claim 35 comprising the further step of discriminating between printed and non-printed portions of the scan line, whereby signals that are below the average amplitude represent printed portions of the check or other document in a given scan line, and those signals above the average in a given scan line represent non-printed portions of the scan line.

37. The method as defined in claim 32 comprising the further step of separating those pixels in each scanning line that are generated in response to said precoded characters from those pixels derived from other areas of said check or other document to provide a P-bit binary scan line sequence according to the formula:
P=(D×S)+t,
where D is the pixel density, S is the height of a MICR character being read, and t is a preselected number of added tolerance bits.

38. The method as defined in claim 38 comprising the further step of spatially filtering said P-bit scan line sequence through the further steps of:
padding each P-bit scan line sequence by adding a 1-bit character at the left and right side of each sequence;
creating M intermediate N-bit numbers from the padded binary number obtained from said preceding step, where M=P/(N-2);
creating a unique 1-bit representation of each intermediate number by assigning the value “1 ” to said intermediate numbers if it comprises N/2 or more “1's” in any place and/or assigning a value “0” if that intermediate number comprises three or less “1's;”
forming a resultant M-bit number from the M, 1-bit equivalences of the intermediate numbers; and,
recognizing said precoded characters by comparing a series of resultant numbers obtained from successive scans of said character to stored values corresponding to sensed characters.

39. The method as defined in claim 38 wherein N=8 and M=8.

40. The method as defined in claim 31 wherein said the steps of concurrently generating a visible image of the check or document being scanned comprises the steps of first locating the pixels within the scan line that represent the bit image of the first character being read, buffering the pixels from said last step, and scanning the buffered bits in descending order starting until either a black pixel is found or a “Top of Character” pixel is reached.

41. The method as defined in claim 40 further comprising the steps of:
correcting for vertical displacements of the check or document being scanned, said last mentioned step comprising the steps of testing for the presence of a black pixel in said buffering step, and changing the Top of Character pixel number to reflect the number of the pixel where the first black pixel was found; and,
looking at the next plurality of successive, lower numbered pixels in the pixel buffer step after a black has been found, and, if none of the next six lower numbered pixels are black, then proceeding to the next phase of image processing.

42. A method for decoding and reading checks or other documents comprising a region containing MICR characters and a separate region containing other visible indicia, said method comprising:
providing a mechanical input region for inputting said check or other document to be scanned;
testing for the presence of a check or other document to be scanned, and if the presence of a check or other document to be scanned is determined, mechanically moving the check or other document for scanning;
illuminating that region of the check containing the MICR characters with infrared light;
separately and concurrently illuminating said separate region with visible light;
separating infrared light from said visible light;
scanning the moving check or other document by concurrently reading visible and infrared light reflected from the check's surface, thereby generating a plurality of scan lines each comprising a plurality of pixels containing bit image information and MICR character data;
decoding the pixels containing MICR character data to read the MICR characters; and,
concurrently generating a visible image of the check or document being scanned by decoding said pixels comprising bit image information.

43. The method as defined in claim 42 further comprising the steps of separating those pixels in each scanning line that are generated from said precoded characters.

44. The method as defined in claim 43 wherein each scan line comprises 1280 pixels, at 400 pixels per inch.

45. The method as defined in claim 43 wherein said scanning step comprises the further step of determining where along each scan line that printed portions of said check or other document are located by comparing the average signal amplitude with the instantaneous signal amplitude.

46. The method as defined in claim 45 comprising the further step of discriminating between printed and non-printed portions of the scan line, whereby signals that are below the average amplitude represent printed portions of the check or other document in a given scan line, and those signals above the average in a given scan line represent non-printed portions of the scan line.

47. The method as defined in claim 42 comprising the further step of separating those pixels in each scanning line that are generated in response to said precoded characters from those pixels derived from other areas of said check or other document to provide a P-bit binary scan line sequence according to the formula:
P=(D×S)+t,
where D is the pixel density, S is the height of a MICR character being read, and t is a preselected number of added tolerance bits.

48. The method as defined in claim 47 comprising the further step of spatially filtering said P-bit scan line sequence through the further steps of:
padding each P-bit scan line sequence by adding a 1-bit character at the left and right side of each sequence to form a P+2 bit number, creating M intermediate N-bit numbers from the padded binary number obtained from said preceding step, where M=P/(N−2);
creating a unique 1-bit representation of each intermediate number by assigning the value “1” to said intermediate numbers if it comprises N/2 or more “1's” in any place and/or assigning a value “0” if that intermediate number comprises less than N/2 “1's;”
forming a resultant M-bit number from the M, 1-bit equivalences of the intermediate numbers; and,
recognizing said precoded characters by comparing a series of resultant numbers obtained from successive scans of said character to stored values corresponding to sensed characters.

49. The method as defined in claim 48 wherein said recognizing step comprises the further steps of correlating each resultant number to a predetermined pattern, and comparing successive patterns to a table of patters indicative of preexisting MICR characters to obtain and recognize the MICR character that has been scanned.

50. The method as defined in claim 47 wherein N=8.

51. The method as defined in claim 47 wherein M=8.

52. The method as defined in claim 47 wherein P=48.

53. A method for decoding and reading MICR characters on checks or other documents, said method comprising the steps of:
providing a mechanical input region for inputting said check or other document to be scanned;
testing for the presence of a check or other document to be scanned, and if the presence of a check or other document to be scanned is determined, mechanically moving the check or other document for scanning;
illuminating that region of the check containing the MICR characters with light;
scanning the check by reading reflected light and generating a plurality of scan lines each comprising a plurality of pixels containing MICR character data;
decoding the pixels containing MICR character data to read the MICR characters by 2 generating a P-bit binary scan line sequence according to the formula:
P=(D×S)+t,
where D is the pixel density, S is the height of a MICR character being read, and t is a preselected number of added tolerance bits; the decoding step comprising the further step of spatially filtering each P-bit binary scan line through the further steps of:
padding each P-bit scan line sequence by adding a 1-bit character at the left and right side of each sequence to form a P+t bit number;
creating M intermediate N-bit numbers from the padded binary number obtained from said preceding step;
creating a unique 1-bit representation of each intermediate number by assigning the value “1” to said intermediate numbers if it comprises N/2 or more “1's” in any place and/or assigning a value “0” if that intermediate number comprises less that N/2 “1's;”
forming a resultant M-bit number from the M, 1-bit equivalences of the intermediate numbers; and,
recognizing said precoded characters by comparing a series of resultant numbers obtained from successive scans of said character to stored values corresponding to sensed characters.

54. The method as defined in claim 53 wherein said recognizing step comprises the further steps of correlating each resultant number to a predetermined pattern, and comparing successive patterns to a table of patters indicative of preexisting MICR characters to obtain and recognize the MICR character that has been scanned.

55. The method as defined in claim 53 wherein N=8.

56. The method as defined in claim 53 wherein M=8.

57. The method as defined in claim 53 wherein P=48.

58. The method as defined in claim 57 wherein N=8 and M=8.
